(19) United States
(12) Patent Application Publication
(10) Pub. No.: US 2007/0092770 A1
(43) Pub. Date: Apr. 26, 2007

(54) Method of measuring alcohol concentration, alcohol concentration measurement apparatus, and fuel cell system including the apparatus

(76) Inventors: Takeshi Obata, Tokyo (JP); Takashi Manako, Tokyo (JP); Satoshi Nagao, Tokyo (JP); Shin Nakamura, Tokyo (JP); Tsutomu Yoshitake, Tokyo (JP); Yoshimi Kubo, Tokyo (JP)

Correspondence Address: HAYES, SOLOWAY P.C., 3450 E. SUNRISE DRIVE, SUITE 140, TUCSON, AZ, 85718, US

(21) Appl. No.: 10/561,390

(22) PCT Filed: Jun. 22, 2004
(86) PCT No.: PCT/JP04/08750

§ 371 Date: Dec. 19, 2005

(30) Foreign Application Priority Data
Jun. 24, 2003 (JP) 2003-179861

(51) Int. Cl. H01M 8/04; H01M 8/10; G01N 27/26

(52) U.S. Cl. 429/22; 429/30; 204/422

(57) ABSTRACT

A fuel cell system includes a fuel cell main body which has a solid polymer electrolytic membrane, a fuel electrode and an oxidant electrode attached to the solid electrolyte membrane; a fuel storage unit which stores liquid fuel; a polymer membrane having a proton conductivity and provided in the fuel storage unit; a concentration detection unit (a first electrode terminal and a second electrode terminal) which detects the alcohol concentration of the liquid fuel in the fuel storage unit based on the alteration of the proton conductivity of said polymer membrane; and a concentration measurement unit.

### TECHNICAL FIELD

The invention relates to a method of measuring alcohol concentration, an alcohol concentration measurement apparatus, and a fuel cell system including the apparatus.

### BACKGROUND ART

A fuel cell is composed of a fuel electrode, an oxidant electrode and an electrolyte disposed between the electrodes. A fuel is supplied to the fuel electrode and an oxidant is supplied to the oxidant electrode to carry out electrochemical reaction to generate electric power. Generally, hydrogen has been used as the fuel, but recently, direct type fuel cells that directly utilize alcohols such as methanol, which is cheap and easier-to-handle, as a fuel have been intensively studied.

When hydrogen is used as the fuel, the reaction on the fuel electrode is represented by the following Formula (1):
3H₂→6H⁺+6e⁻ (1)

When methanol is used as the fuel, the reaction on the fuel electrode is represented by the following Formula (2):
CH₃OH+H₂O→6H⁺+CO₂+6e⁻ (2)

In either case, the reaction on the oxidant electrode is represented by the following Formula (3).
3/2O₂+6H⁺+6e³¹ →3H₂O (3)

In particular, direct type fuel cells, which can generate protons from an aqueous methanol solution and thus do not demand a converter or the like, miniaturization and light weight can be achieved. They are also characteristic in that the energy density thereof is extremely higher as they use a liquid aqueous methanol solution as the fuel.

However, with respect to the direct type fuel cell, depending on the power generation state, the alcohol concentration in the fuel is changed. To keep the electric power of the fuel cell stable, it is required to keep the alcohol concentration in the fuel in a proper range. Therefore, a fuel cell system requires an apparatus for detecting the alcohol concentration in the fuel.

For example, patent document 1 discloses a sensor for measuring the alcohol concentration in a liquid. The sensor is composed by providing a coating polythiophene type conductive polymer between electrodes and making the resistance changed corresponding to the alcohol concentration.

Further, patent documents 2 and 3 disclose sensors for measuring methanol concentrations in liquids using fuel cell-like cells including anodes and cathodes sandwiching electrolyte membranes (see FIG. 15 of patent document 2, and FIG. 6 of patent document 3). In these cells, catalytic electrodes such as Pt—Ru as the anode and Pt as the cathode are used. By applying constant voltage between the anode and the cathode of the cell structured as above, reactions in which methanol is converted to carbon dioxide on the anode and proton is converted to hydrogen on the cathode are caused and thus electric current flows between the anode and the cathode. The methanol concentration in the liquids can be measured by measuring the electric current values.
[Patent Document 1] Japanese Laid-open patent publication No.H6-265503
[Patent Document 2] U.S. Pat. No. 6,254,748
[Patent Document 3] U.S. Pat. No. 6,306,285

### DISCLOSURE OF THE INVENTION

However, as for the sensor with the structure described in the above-mentioned patent document 1, the alcohol concentration in a liquid is detected based on the fact that conformation of the side chains differs between the case that the sensor is put in a good solvent such as hexane or gasoline and the case that the sensor is put in a poor solvent such as methanol and water. Therefore, it is difficult to precisely detect the alcohol concentration in an aqueous alcohol solution, which is a poor solvent.

In the case of the sensors with the structures described in the above-mentioned patent document 2 and the patent document 3, it is required to prepare a fuel cell-like cell for measuring the methanol concentration and also, it is required to use expensive metal catalyst such as Pt as anodes and cathodes. Further, since hydrogen gas is generated in cathodes, it is required to remove hydrogen gas.

In view of the above-mentioned state, it is an object of the invention to provide an alcohol concentration measurement apparatus, a fuel cell system including the apparatus, and a method of measuring the alcohol concentration, capable of detecting the alcohol concentration with a simple structure.

According to the present invention, there is provided a fuel cell system using a liquid fuel containing an alcohol comprising: a fuel cell main body including a solid polymer electrolytic membrane, and a fuel electrode and an oxidant electrode attached to the solid electrolyte membrane; a container containing the liquid fuel; a polymer membrane having proton conductivity and provided inside of the container or at the wall portion of the container; and a concentration detection unit which detects the alcohol concentration of the liquid fuel in the container based on the alteration of the proton conductivity of the polymer membrane when the polymer membrane is immersed or impregnated with the liquid fuel.

The fuel cell main body may be a direct type in which liquid fuel is directly supplied to the fuel electrode or may be a type in which hydrogen obtained by reforming liquid fuel is used as fuel. The container containing the liquid fuel includes a fuel electrode tank provided at the fuel electrode of the fuel cell main body, a buffer tank which stores fuel to be supplied to the fuel electrode tank, a cartridge, and a pipeline connecting them and may have any structure if the polymer membrane may be impregnated with the liquid fuel.

The polymer membrane is structured to be impregnated with the liquid fuel in the container and made of a material having proton conductivity changeable depending on the alcohol concentration of the liquid fuel. Materials containing protonic acid group may be used as the polymer membrane.

The fuel cell system of the invention can detect the alcohol concentration in a liquid fuel with a simple structure. Since the fuel cell system of the invention can detect the alcohol concentration in the liquid fuel based on the alteration of the proton conductivity of the polymer membrane, the alcohol concentration may be detected with a high precision even in an aqueous alcohol solution, which is a poor solvent.

In the fuel cell system of the invention, the concentration detection unit may include a pair of electrode terminals attached to the polymer membrane, a resistance measurement unit which measures the resistance value between the electrode terminals, and a concentration calculation unit which calculates the alcohol concentration of the liquid fuel based on the resistance value measured by the resistance measurement unit.

Here, since the polymer membrane is made of a material having proton conductivity changeable depending on the alcohol concentration, in the case electric current is applied between the electrode terminals through the polymer membrane, the resistance value between the electrode terminals changes depending on the alcohol concentration in the liquid fuel. The concentration detection unit may store the reference data showing the correlation of the resistance value between the electrode terminals and the alcohol concentration and the concentration calculation unit may calculate the alcohol concentration of the liquid fuel based on the reference data.

The concentration detection unit may include three or more electrode terminals and for example, may include four electrode terminals. In this case, one pair of the electrode terminals may be used for electric current measurement and the other pair of the electrode terminals may be used for voltage measurement. The electrode terminals may be formed on the surface of the polymer membrane or in the polymer membrane. The electrode terminals may be provided in the liquid fuel or may be placed not to directly contact with the liquid fuel. The electrode terminals may be prevented from corrosion with the liquid fuel by keeping the electrode terminals not directly contact with the liquid fuel. Accordingly, the electrode terminals may be maintained stably. The electrode terminals may be made any materials which have conductivity. The electrode terminals may be made of, for example, gold, silver, platinum, aluminum, or stainless steel.

According to the invention, since no electrode catalyst is required unlike the sensors disclosed in the patent document 2 and the patent document 3, the concentration detection unit can be produced by simple process. Further since no metal catalyst is required in the concentration detection unit, the fuel cell system can be produced at a low cost. Further, in the sensors disclosed in the patent document 2 and the patent document 3, the alcohol concentration in the liquid fuel is detected based on the output of the electrode reactions, whereas in the fuel cell system of the invention, only the resistance value of the current flowing through the polymer membrane is measured and therefore, no hydrogen gas is evolved in the oxidant electrode and therefore the structure can be made simple. Further, in the above-mentioned patent document 2 and the patent document 3, since the alcohol concentration of the liquid fuel is detected based on the output of the electrode reactions, it may be possible to measure the alcohol concentration inaccurately owing to fluctuation of the output of the electrode reactions attributed to deterioration of the catalyst electrodes. In the fuel cell system of the invention, since no catalytic reaction is utilized, there occurs no such a problem attributed to the deterioration of the catalyst.

In the fuel cell system of the invention, the electrode terminals of the concentration detection unit may be placed at the outside of the container. Also, the concentration detection unit may include a hydrophobic membrane covering the electrode terminals.

In the fuel cell system of the invention, a portion of the solid polymer electrolytic membrane may be used as the polymer membrane. In this case, in the solid electrolyte membrane, the electrode terminals may be formed in the area where the catalyst layer is not formed.

In the fuel cell system of the invention, the fuel cell system may further include a different concentration fuel storage unit which stores a liquid fuel with a different alcohol concentration from that of the liquid fuel in the container; a supply unit which supplies the liquid fuel to the container from the different concentration fuel storage unit; and a control unit which adjusts the supply amount of the liquid fuel to be supplied by the supply unit depending on the alcohol concentration of the liquid fuel in the container detected by the concentration detection unit. The liquid fuel contained in the different concentration fuel storage units may have a higher concentration or a lower concentration than the liquid fuel in the container. The fuel cell system of the invention may include a plurality of different concentration fuel storage units. The different concentration fuel storage units may contain water containing no alcohol. In this case, after the liquid fuel is supplied to the fuel cell main body, water produced in the fuel electrode may be recovered in the different concentration fuel storage unit and circulated. The fuel cell system of the invention can detect the concentration alteration of the liquid fuel in the container and liquid fuel with a proper alcohol concentration can be supplied to the fuel cell main body.

In the fuel cell system of the invention, the container may be provided in a cartridge detachable from the fuel cell main body.

The fuel cell system of the invention may further include a fuel electrode tank which has a fuel injection inlet and supplies the liquid fuel to the fuel electrode; and a cartridge which has a fitting unit to be fitted with the fuel injection inlet of the fuel electrode tank and is detachable from the fuel electrode tank, wherein the container may be provided in the cartridge.

The fuel cell system of the invention may further include fuel electrode tank having a fuel injection inlet and supplying the liquid fuel to the fuel cell main body, the container may have a fitting unit to be fitted with the fuel injection inlet of the fuel electrode tank and a first connection unit which connects to the supply unit and may be detachable from the fuel electrode tank and the supply unit, and the different concentration fuel storage unit may have a second connection unit which is connected to the supply unit and may be detachable from the supply unit. The container and the different concentration fuel storage units may be provided in a cartridge. The container and the different concentration fuel storage unit may be united in one cartridge.

The fuel cell system of the invention may further include a temperature sensor which measures the temperature in the liquid fuel in the container, wherein the concentration detection unit may correct the alcohol concentration of the liquid fuel in the container based on the temperature measured by the temperature sensor.

The fuel cell system of the invention may further include a pH measurement unit which measures pH of the liquid fuel in the container, wherein the concentration detection unit may correct the alcohol concentration of the liquid fuel in the container based on the pH measured by the pH measurement unit.

The fuel cell system of the invention may further include an alarm reporting unit which reports an alarm and a control unit which controls the alarm reporting unit for the report of the alarm when the alcohol concentration of the liquid fuel in the container detected by the concentration detection unit is not within a predetermined range. The control unit may control the alarm reporting unit to report the alarm when the alcohol concentration of the liquid fuel in the container reaches a predetermined value or lower. In this manner, that run out of the fuel in liquid fuel in the container can be informed to a user who is using an electronic appliance in which the fuel cell system is built in.

The fuel cell system of the invention may include a plurality of polymer membranes with different proton conductivity depending on the temperature and pH and the concentration detection unit can detect the alcohol concentration in the liquid fuel based on the respective alterations of the proton conductivity of the plurality of the polymer membranes in consideration of the temperature or pH of the liquid fuel in the container.

According to the invention, there is provided an alcohol concentration measurement apparatus, comprising: a polymer membrane which has a proton conductivity, the proton conductivity being changeable when being immersed or impregnated with an alcohol-containing liquid, in accordance with the alcohol concentration of the liquid; and a concentration detection unit which detects the alcohol concentration of the liquidbased on the alteration of the proton conductivity of the polymer membrane.

In the alcohol concentration measurement apparatus of the invention, the concentration detection unit may include a pair of electrode terminals attached to the polymer membrane, a resistance measurement unit which measures the resistance value between the electrode terminals, and a concentration calculation unit which converts the resistance value measured by the resistance measurement unit into the alcohol concentration of the liquid.

According to the present invention, there is provided a method of measuring the alcohol concentration, comprising: immersing an alcohol-containing liquid which is a target to be measured to a polymer membrane having a proton conductivity; detecting the alteration of the proton conductivity of the polymer membrane; and detecting the alcohol concentration in the liquid based on the alteration of the proton conductivity.

In the method of measuring the alcohol concentration of the invention, the detecting the alteration of the proton conductivity may include measuring the resistance value of a pair of electrode terminals attached to the polymer membrane, and wherein the detecting the alcohol concentration may include calculating the alcohol concentration of the liquid based on the resistance value.

The method of measuring the alcohol concentration of the invention, may further include saturating the liquid with carbon dioxide gas before the detecting the alteration of the proton conductivity of the polymer membrane.

According to the present invention, there is provided a fuel storage container detachable to a fuel cell system which includes a fuel cell main body, a first electrode terminal, a second electrode terminal, and a voltage application unit which applies voltage between the first electrode terminal and the second electrode terminal, and reserving a liquid fuel supplied to the fuel cell main body, comprising: a polymer membrane having a proton conductivity; and a third electrode terminal and a fourth electrode terminal which are attached to the polymer membrane and electrically connected to the first electrode terminal and the second electrode terminal, respectively.

According to the present invention, there is provided a fuel cell system using a liquid fuel containing an alcohol comprising: a fuel cell main body including a solid polymer electrolytic membrane, and a fuel electrode and an oxidant electrode attached to the solid electrolyte membrane; a container containing the liquid fuel; a polymer membrane provided inside of the container or at the wall portion of the container and changeable in size in accordance with the concentration of the alcohol concentration of the liquid fuel when being impregnated with the liquid fuel; and a concentration detection unit which detects the alteration degree of the size of the polymer membrane and detects the alcohol concentration of the liquid fuel in the container based on the alteration degree of the size.

The fuel cell main body may be a direct type in which liquid fuel is directly supplied to the fuel electrode or may be a type in which hydrogen obtained by reforming liquid fuel is used as fuel. The container containing the liquid fuel includes a fuel electrode tank provided at the fuel electrode of the fuel cell main body, a buffer tank which stores fuel to be supplied to the fuel electrode tank, a cartridge, and a pipeline connecting them and may have any structure if the polymer membrane may be impregnated with the liquid fuel.

The polymer membrane is structured to be impregnated with the liquid fuel in the container and made of a material whose size changes depending on the alcohol concentration and water concentration in the liquid fuel. The polymer membrane is made of a material whose size changes by expansion or shrinkage depending on the alcohol concentration and water concentration in the liquid fuel.

The fuel cell system of the invention can detect the alcohol concentration in a liquid fuel with a simple structure. Since the fuel cell system of the invention can detect the alcohol concentration in the liquid fuel based on the size alteration of the polymer membrane in the liquid fuel, the alcohol concentration can be detected with a high precision even in an aqueous alcohol solution, which is a poor solvent.

In the fuel cell system of the invention, the concentration detection unit may include a strain gauge attached to the polymer membrane, a resistance measurement unit which measures the resistance alteration of the strain gauge, and a concentration calculation unit which converts the resistance alteration measured by the resistance measurement unit into the alcohol concentration of the liquid fuel.

In the fuel cell system of the invention, the polymer membrane may contain a protonic acid group.

In the fuel cell system of the invention, a portion of the solid polymer electrolytic membrane may be used as the polymer membrane.

In the fuel cell system of the invention, the concentration detection unit may include a capacitor composed so as to sandwich the polymer membrane, an electric capacity measurement unit which measures the electric capacity of the capacitor, and a concentration calculation unit which detects the size alteration of the polymer membrane based on the alteration of the electric capacity measured by the electric capacity measurement unit and converts the size alteration degree into the alcohol concentration of the liquid fuel. In this case, an insulating material may be used as the polymer membrane. As such a material, a polymer membrane having sulfonic acid groups usable for the solid electrolyte membrane of the fuel cell main body may be used after it is changed to show insulating property by radiation of electron beam, UV, or x-ray or being immersed in a salt.

In the fuel cell system of the invention, the concentration detection unit may include a quartz oscillator attached to the polymer membrane, a resonance frequency characteristic measurement unit which detects the alteration of the resonance frequency of the quartz oscillator, and a concentration calculation unit which converts the resonance frequency characteristic measured by the resonance frequency characteristic measurement unit into the alcohol concentration of the liquid fuel.

In the fuel cell system of the invention, the polymer membrane may be crosslinked. Accordingly, even if the polymer membrane is expanded and shrunk repeatedly by alteration of the alcohol concentration in the liquid fuel, deterioration of the material can be suppressed.

The fuel cell system of the invention may further include a different concentration fuel storage unit which stores a liquid fuel with a different alcohol concentration from that of the liquid fuel in the container; a supply unit which supplies the liquid fuel to the container from the different concentration fuel storage unit; and a control unit which adjusts the supply amount of the liquid fuel to be supplied by the supply unit depending on the alcohol concentration of the liquid fuel in the container detected by the concentration detection unit. The liquid fuel contained in the different concentration fuel storage units may have a higher concentration or a lower concentration than the liquid fuel in the container. The fuel cell system may include a plurality of different concentration fuel storage units. The different concentration fuel storage units may contain water containing no alcohol. In this case, after the liquid fuel is supplied to the fuel cell main body, water produced in the fuel electrode can be recovered in the different concentration fuel storage unit and circulated. The fuel cell system of the invention can detect the concentration alteration of the liquid fuel in the container and liquid fuel with a proper alcohol concentration can be supplied to the fuel cell main body.

In the fuel cell system of the invention, the container may be provided in a cartridge detachable from the fuel cell main body.

The fuel cell system of the invention may further include a fuel electrode tank having a fuel injection inlet and supplying the liquid fuel to the fuel electrode and a cartridge having a fitting unit to be fitted with the fuel injection inlet of the fuel electrode tank and detachable from the fuel electrode tank, wherein the container may be provided in the cartridge.

The fuel cell system of the invention may further include fuel electrode tank having a fuel injection inlet and supplying the liquid fuel to the fuel cell main body, the container may have a fitting unit to be fitted with the fuel injection inlet of the fuel electrode tank and a first connection unit which connects to the supply unit and may be detachable from the fuel electrode tank and the supply unit, and the different concentration fuel storage unit may have a second connection unit which is connected to the supply unit and may be detachable from the supply unit. The container and the different concentration fuel storage units may be provided in a cartridge. The container and the different concentration fuel storage unit may be united in one cartridge.

The fuel cell system of the invention may further include a temperature sensor which measures the temperature in the liquid fuel in the container, wherein the concentration detection unit may correct the alcohol concentration of the liquid fuel in the container based on the temperature measured by the temperature sensor.

The fuel cell system of the invention the fuel cell system may further include a pH measurement unit which measures pH of the liquid fuel in the container, wherein the concentration detection unit may correct the alcohol concentration of the liquid fuel in the container based on the pH measured by the pH measurement unit.

The fuel cell system of the invention may further include an alarm reporting unit which reports an alarm; and a control unit which instructs the alarm reporting unit for reporting an alarm when the alcohol concentration of the liquid fuel in the container detected by the concentration detection unit is not within a predetermined range. The control unit may control the alarm reporting unit to report the alarm when the alcohol concentration of the liquid fuel in the container reaches a predetermined value or lower. In this manner, that run out of the fuel in liquid fuel in the container can be informed to a user who is using an electronic appliance in which the fuel cell system is built in.

The fuel cell system of the invention may include a plurality of polymer membranes having different size alteration degrees with respect to temperature and pH, wherein the concentration detection unit may detect the alcohol concentration in the liquid fuel based on the respective size alteration degrees of the plurality of polymer membranes in consideration of the temperature or pH of the liquid fuel in the container.

According to the present invention, there is provided an alcohol concentration measurement apparatus comprising: a polymer membrane which shows size alteration when an alcohol-containing liquid is immersed therewith, depending on the concentration of the alcohol concentration in the liquid; and a concentration detection unit which detects the alteration degree of the size of the polymer membrane and detects the alcohol concentration of the liquid based on the alteration degree of the size.

In the alcohol concentration measurement apparatus of the invention, the concentration detection unit may include a strain gauge attached to the polymer membrane, a resistance measurement unit which measures the resistance alteration of the strain gauge, and a concentration calculation unit which converts the resistance alteration measured by the resistance measurement unit into the alcohol concentration of the liquid fuel.

According to the present invention, there is provided a method of measuring the alcohol concentration, comprising: immersing an alcohol-containing liquid which is a target to be measured to a polymer membrane showing size alteration when being impregnated with the liquid; detecting the size alteration of the polymer membrane; and detecting the alcohol concentration of the liquid based on the size alteration of the polymer membrane.

In the method of measuring the alcohol concentration of the invention, the detecting the size alteration may include measuring the resistance alteration of a strain gauge attached to the polymer membrane, and the detecting the alcohol concentration may include converting the resistance alteration measured in the measuring resistance into the alcohol concentration of the liquid

In the method of measuring the alcohol concentration of the invention, the detecting the size alteration may include measuring the electric capacity of a capacitor composed so as to sandwich the polymer membrane, and the detecting the alcohol concentration may include detecting the size alteration of the polymer membrane based on the alteration of the electric capacity measured in the measuring the electric capacity, and converting the size alteration degree into the alcohol concentration of the liquid fuel.

In the method of measuring the alcohol concentration of the invention, the detecting the size alteration may include measuring the alteration of resonance frequency of a quartz oscillator attached to the polymer membrane, and the detecting the alcohol concentration may include detecting the size alteration of the polymer membrane based on the alteration of the resonance frequency measured in the measuring the resonance frequency, and converting the size alteration degree into the alcohol concentration of the liquid fuel.

According to the present invention, there is provided a fuel storage container detachable to a fuel cell system which includes a fuel cell main body, a first electrode terminal, a second electrode terminal, and a voltage application unit which applies voltage between the first electrode terminal and the second electrode terminal, and reserving a liquid fuel supplied to the fuel cell main body, comprising: a polymer membrane changeable in size when being impregnated with an alcohol-containing liquid; a strain gauge which is attached to the polymer membrane; and a third electrode terminal and a fourth electrode terminal which are electrically connected to the first electrode terminal and the second electrode terminal, respectively to output resistance alteration of the strain gauge.

Accordingly, any combination of the constituent elements, metal substitution of the constituent element and representation with methods and processes, and systems, all of which are effective as a preferred embodiment of the invention.

According to the invention, an alcohol concentration measurement apparatus, a fuel cell system including the apparatus, a method of measuring the alcohol concentration, capable of detecting the alcohol concentration with a simple structure are provided.

### BRIEF DESCRIPTION OF THE DRAWINGS

The above-mentioned objects of the invention and other objects, features and advantages thereof will be more readily apparent from the following preferred embodiments and appended the drawings.

FIG. 1 is a drawing of one example of a fuel cell system of an embodiment of the invention.

FIG. 2 is a drawing showing a sensor in detail.

FIG. 3 is a drawing showing another sensor.

FIG. 4 is a drawing showing also another sensor.

FIG. 5 is a drawing showing another example of the structure of a fuel cell system of the embodiment.

FIG. 6 is a drawing showing the structure of the concentration measurement unit shown in FIG. 1 in detail.

FIG. 7 is a drawing showing the structure of a fuel cell system further including a pH sensor and a temperature sensor.

FIG. 8 is a drawing showing a concentration measurement unit including three or more types of polymer membranes in combination having different electric resistance with respect to temperature and pH.

FIG. 9 is a drawing showing the structure of the fuel supply processing unit shown in FIG. 1 in detail.

FIG. 10 is a drawing showing another example of the structure of a fuel cell system.

FIG. 11 is a drawing showing another example of the structure of a fuel cell system.

FIG. 12 is a drawing showing a modified example of a sensor.

FIG. 13 is a cross-sectional view schematically showing a unit cell of a fuel cell main body.

FIG. 14 is a drawing showing one example of the structure of a fuel cell system of an embodiment of the invention.

FIG. 15 is a drawing of a buffer tank in a cartridge and a fuel electrode tank in the main body side shown in FIG. 14.

FIG. 16 is a drawing showing another example of the structure of a fuel cell system.

FIG. 17 is a drawing showing another example of the structure of a fuel cell system.

FIG. 18 is a drawing of another example of the cartridge shown in FIG. 15.

FIG. 19 is a graph showing correlation between the methanol concentration and the resistance value.

FIG. 20 is a drawing of one example of the structure of a fuel cell system of an embodiment of the invention.

FIG. 21 is a drawing showing a sensor in detail.

FIG. 22 is a drawing of another example of the structure of a fuel cell system of an embodiment of the invention.

FIG. 23 is a drawing showing the structure of the concentration measurement unit shown in FIG. 20 in detail.

FIG. 24 is a drawing showing the structure of a fuel cell system further including a pH sensor and a temperature sensor.

FIG. 25 is a drawing showing a concentration measurement unit including three or more types of polymer membranes in combination having different electric resistance with respect to temperature and pH.

FIG. 26 is a drawing showing the structure of the fuel supply processing unit shown in FIG. 20 in detail.

FIG. 27 is a drawing showing another example of the structure of a fuel cell system.

FIG. 28 is a drawing showing another example of the structure of a fuel cell system.

FIG. 29 is a drawing showing a modified example of a sensor.

FIG. 30 is a drawing showing another example of the structure of a fuel cell system.

FIG. 31 is a drawing showing a sensor in detail.

FIG. 32 is a drawing of one example of the structure of a fuel cell system of an embodiment of the invention.

FIGS. 33 is a schematic drawing of a buffer tank in a cartridge and a fuel electrode tank in the main body side shown in FIG. 32.

FIG. 34 is a drawing showing another example of the structure of a fuel cell system.

FIG. 35 is a drawing showing another example of the structure of a fuel cell system.

FIG. 36 is a drawing showing another example of the cartridge shown in FIG. 33.

FIG. 37 is a drawing showing another example of a fuel supply processing unit.

FIG. 38 is a drawing showing another example of the structure of a fuel cell system.

FIG. 39 is a drawing showing another example of a sensor.

FIG. 40 is a drawing showing another example of a sensor.

FIG. 41 is a drawing showing another example of a sensor.

FIG. 42 is a drawing showing another example of the structure of a fuel cell system.

FIG. 43 is a drawing showing another example of the structure of a fuel cell system.

### BEST MODE FOR CARRYING OUT THE INVENTION

The applications of the fuel cell system described in the following embodiments are not particularly limited, however the fuel cell system can be used appropriately for compact electric devices such as cellular phones, note-type portable personal computers, PDAs (Personal Digital Assistants), various types of cameras, navigation systems, portable music players and the like.

(First Embodiment)

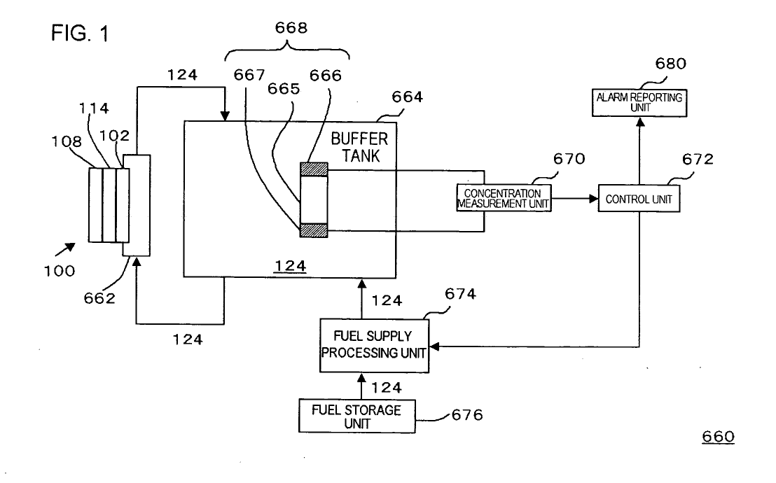

FIG. 1 is a drawing showing one example of the structure of a fuel cell system of a first embodiment of the invention. In FIG. 1, the fuel cell system 660 includes a fuel cell main body 100, a fuel electrode tank 662, a buffer tank 664, a sensor 668, a concentration measurement unit 670, a control unit 672, a fuel supply processing unit 674 a fuel storage unit 676, and an alarm reporting unit 680.

In this embodiment, organic liquid fuel such as methanol, ethanol, dimethyl ether, or other alcohols may be used as fuel 124. The organic liquid fuel may be in form of an aqueous solution.

The fuel cell main body100 includes a solid electrolyte membrane 114, and a fuel electrode 102 and an oxidant electrode 108 attached to the solid electrolyte membrane 114. As the oxidant to be supplied to the oxidant electrode 108, generally, air may be used, however oxygen gas may be supplied. The detailed structure of the fuel cell main body 100 will be described later.

Also in this embodiment, the fuel storage unit 676 contains fuel 124 having a higher alcohol concentration than the fuel 124 supplied to the fuel electrode 102.

The fuel 124 to be supplied to the fuel electrode 662 is introduced into the buffer tank 664. The sensor 668 is used for detecting the alcohol concentration of the fuel 124 in the buffer tank 664. The sensor 668 includes a polymer membrane 665, a first electrode terminal 666, and a second electrode terminal 667. The polymer membrane 665 is a polymer membrane having proton conductivity. The polymer membrane 665 is composed so as to impregnate the membrane with the fuel 124 in the buffer tank 664 and is made of a material whose proton conductivity changes depending on the alcohol concentration in the fuel 124. The fuel cell system 660 of this embodiment can detect the methanol concentration in the fuel 124 in the buffer tank 664 based on the alteration of the proton conductivity of the polymer membrane 665.

The polymer membrane 665 may be made of any material provided that the proton conductivity of which is changeable in accordance with the alcohol concentration in the fuel 124. For example, it may be made of the material same as those for the solid electrolyte membrane 114 of the fuel cell main body 100. Typical examples of the favorable materials include organic polymers having a polar group such as a strong acid group such as sulfone group, phosphorus acid group, phosphonic group, and phosphine group or a weak acid group such as carboxyl group. Typical examples as such the organic polymers include:

aromatic group-containing polymers such as sulfonated poly(4-phenoxybenzoyl-1,4-phenylene) and alkyl-sulfonated polybenzoimidazole;

copolymers such as polystyrenesulfonic acid copolymers, polyvinylsulfonic acid copolymers, crosslinked alkylsulfonic acid derivatives, and copolymers of fluorine-containing polymers having a fluoroplastic structure and a sulfonic acid;

copolymers of an acrylamide such as acrylamide-2-methylpropanesulfonic acid and an acrylate such as n-butyl methacrylate;

sulfonic acid group-containing perfluorocarbons (Nafion (registered trademark; manufactured by E.I. du Pont de Nemours and Company), Aciplex (manufactured by Asahi Kasei Corp.));

carboxyl group-containing perfluorocarbon (Flemion (registered trademark) S film (manufactured by Asahi Glass Co., LTD.));

aromatic polyether, polyphenylene sulfide, polyimide, polyphosphazene, trifluorostyrene copolymer (BAM3G, manufactured by Ballard Advanced Materials Corporation) and the like.

The polymers exemplified above further substituted with a crosslinkable substituent group such as a vinyl group, an epoxy group, anacryl group, amethacryl group, a cinnamoyl group, amethylol group, an azide group, or a naphthoquinonediazide group may be used as they are or after being crosslinked by irradiating radiation, ultraviolet, electron ray or the like in molten state.

The first electrode terminal 666 and the second electrode terminal 667 are placed at a distance from each other on the surface of the polymer membrane 665 or in the polymer membrane 665. Since the polymermembrane 665 is made of a material whose proton conductivity is changeable depending on the alcohol concentration, when the electric current is applied between the first electrode terminal 666 and the second electrode terminal 667 through the polymer membrane 665, the resistance value between the first electrode terminal 666 and the second electrode terminal 667 changes depending on the alcohol concentration in the fuel 124 in the buffer tank 664. The concentration measurement unit 670 measures the alcohol concentration of the fuel 124 in the buffer tank 664 based on the resistance value between the first electrode terminal 666 and the second electrode terminal 667. The detailed structure of the concentration measurement unit 670 will be described in later.

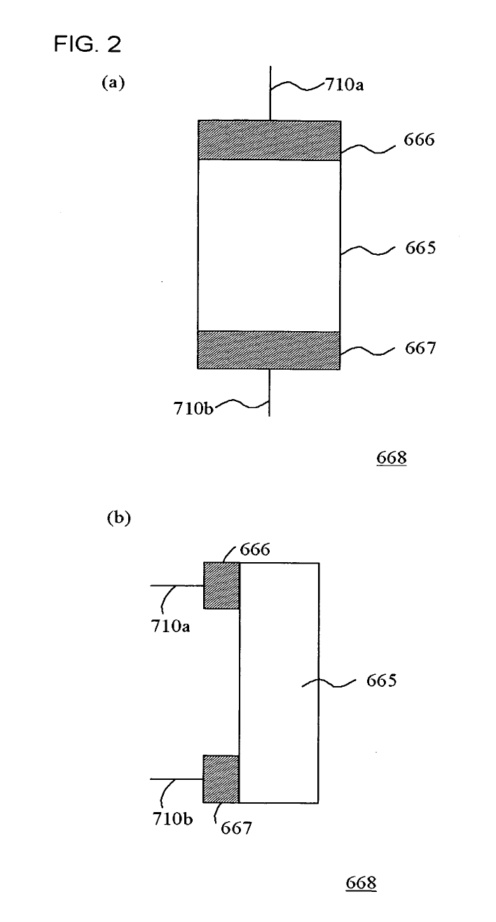

FIG. 2 is a drawing showing the sensor 668 in detail. FIG. 2(a) is a drawing showing a face of the sensor 668 where the first electrode terminal 666 and the second electrode terminal 667 are formed. FIG. 2(b) is a side view of FIG. 2(a). The first electrode terminal 666 and the second electrode terminal 667 are made of any materials provided that the materials can be stably exist in the fuel 124 and have conductivity. The first electrode terminal 666 and the second electrode terminal 667 can be stuck to the polymer membrane 665 by a conductive paste. As the conductive pastes, polymer pastes containing metals such as gold and silver may be used. The first electrode terminal 666 and the second electrode terminal 667 are electrically connected to concentration measurement unit 670 shown in FIG. 1 through the wiring 710a and the wiring 710b, respectively.

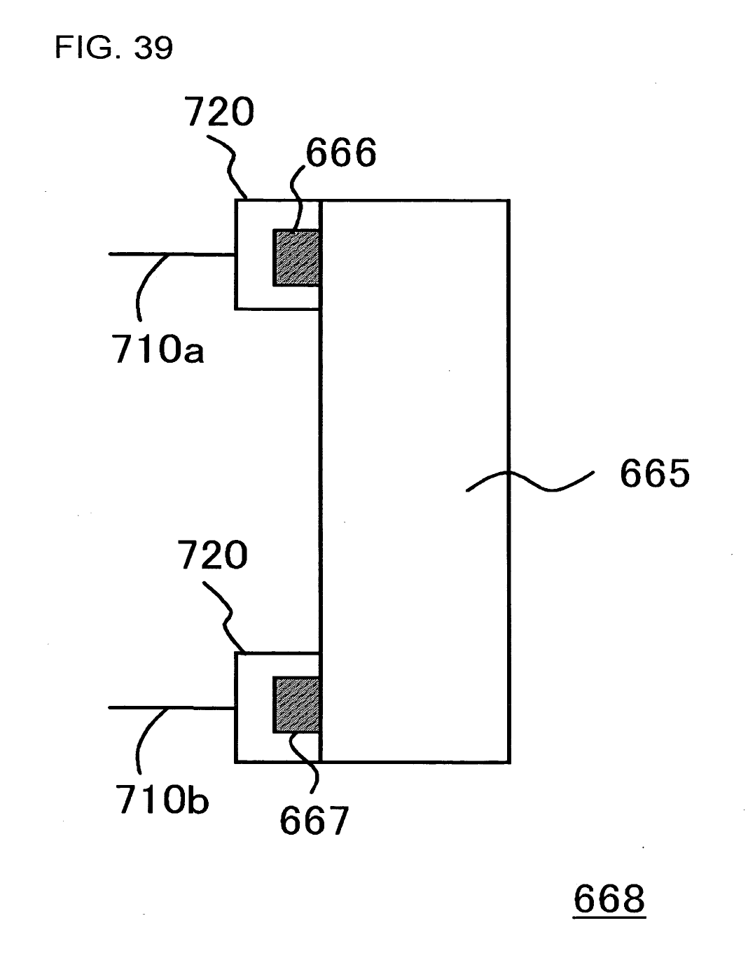

As shown in FIG. 39, the sensor 668 may have a structure in which the surfaces of the first electrode terminal 666 and the second electrode terminal 667 are coated with hydrophobic membranes 720 such as Teflon (registered trademark). With this structure, even if the sensor 668 is introduced into the buffer tank 664, the first electrode terminal 666 and the second electrode terminal 667 are prevented from direct contact with the fuel in the buffer tank 664. Therefore, the first electrode terminal 666 and the second electrode terminal 667 are prevented from corrosion with the fuel. Accordingly, the first electrode terminal 666 and the second electrode terminal 667 can be kept stable.

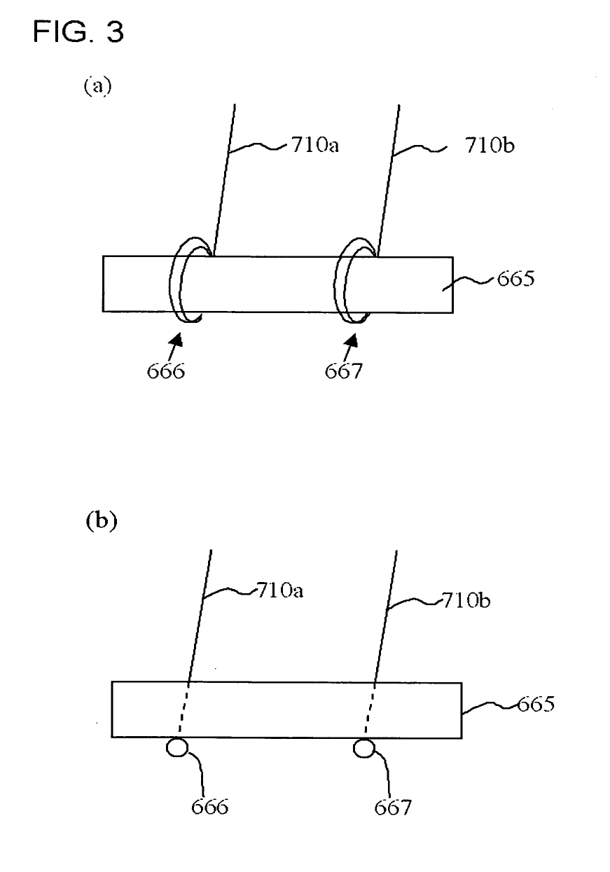

FIG. 3 is a drawing showing another example of the sensor 668. As shown in FIG. 3(a), the first electrode terminal 666 and the second electrode terminal 667 may be composed by the wiring 710a and the wiring 710b formed around the polymer membrane 665. Also, as shown in FIG. 3(b), the first electrode terminal 666 and the second electrode terminal 667 may be formed by having the wiring 710a and the wiring 710b penetrate the polymer membrane 665 in the thickness direction thereof and making anchors by the penetrated portion of the wiring 710a and the wiring 710b to form.

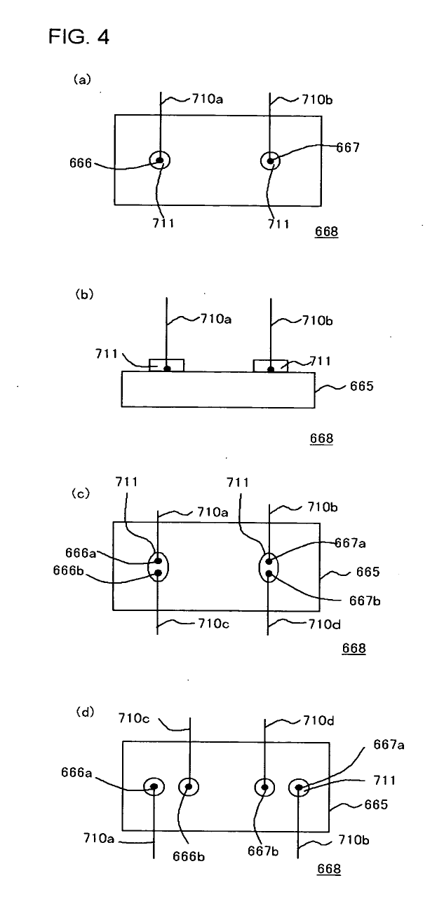

FIG. 4 is a drawing showing another example of the sensor 668. As shown in FIG. 4(a), the first electrode terminal 666 and the second electrode terminal 667 may be composed by fixing the wiring 710a and the wiring 710b on the polymer membrane 665 by the conductive paste 711. As the paste, as same as described above, polymer pastes containing metal such as gold and silver may be used. FIG. 4(b) is a side view of the sensor 668 shown in FIG. 4(a). As for the previously described first electrode terminal 666 and the second electrode terminal 667 shown in FIG. 3(a) and FIG. 3(b), the wiring 710a and the wiring 710b can be firmly fixed to the polymer membrane 665 by a similar conductive paste as well.

Further, as shown in FIG. 4(c) and FIG. 4(d), the sensor 668 may be formed to include four electrodes of an electrode terminal 666a, an electrode terminal 666b, an electrode terminal 667a, and an electrode terminal 667d. The respective electrode terminals 666a, 666b, 667a, and 667b are electrically connected to the concentration measurement unit 670 (see FIG. 1) through a wiring 710a, a wiring 710b, a wiring 710c, and a wiring 710d, respectively. The concentration measurement unit 670 may be used, for example, for measuring the electric current flowing between the electrode terminal 666a and the electrode terminal 667a and for measuring the voltage between the electrode terminal 666b and the electrode terminal 667b.

Referring back to FIG. 1, the alcohol concentration of the fuel 124 in the buffer tank 664 measured by the concentration measurement unit 670 is transmitted to the control unit 672. The fuel supply processing unit 674 carries out the process for supplying the fuel 124 to the buffer tank 664 from the fuel storage unit 676. The control unit 672 determines whether the alcohol concentration measured by the concentration measurement unit 670 is within a proper range or not and controls the fuel supply processing unit 674 so as to have the alcohol concentration of the fuel 124 in the buffer tank 664 within a proper range. The fuel supply processing unit 674 controls the supply amount of the fuel 124 to be supplied to the buffer tank 664 from the fuel storage unit 676 based on the control of the control unit 672. The detailed structure of the fuel supply processing unit 674 will also be described later.

The control unit 672 makes the alarm reporting unit 680 generate an alarm when the alcohol concentration of the fuel 124 in the buffer tank 664 is not corrected to be within the proper range even after the control of the fuel supply processing unit 674 is repeated.

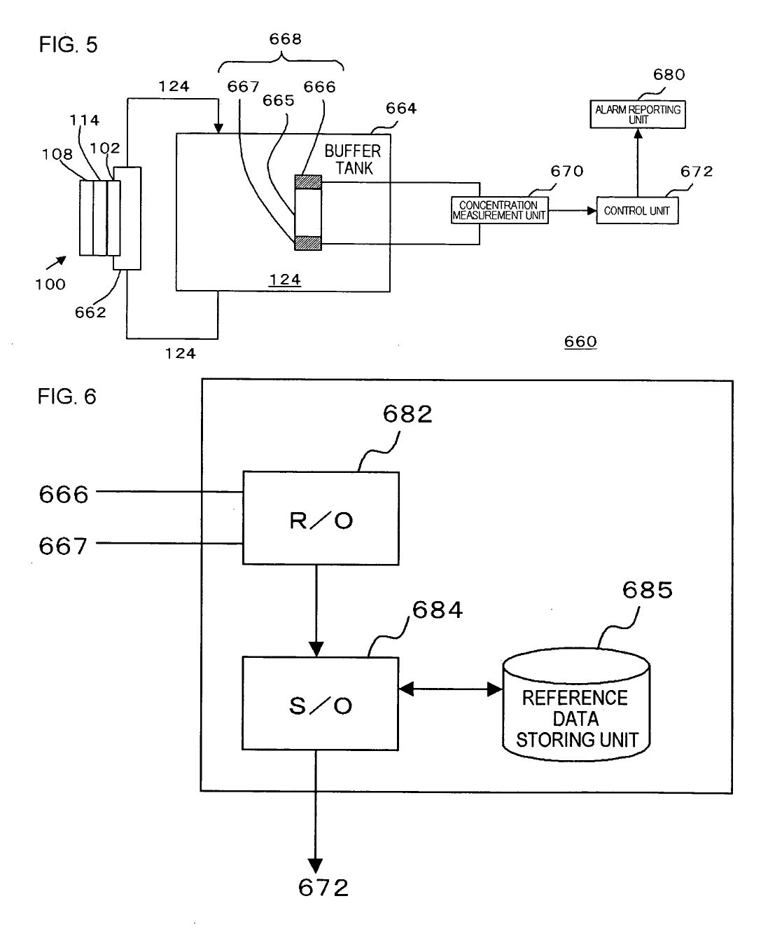

As shown in FIG. 5, the fuel cell system 660 may not include the fuel storage unit 676 and the fuel supply processing unit 674. In this case, the control unit 672 makes the alarm reporting unit 680 generate an alarm when the alcohol concentration measured by the concentration measurement unit 670 is not within the proper range. When electrochemical reaction is caused in the fuel cell main body 100 by circulating the fuel 124 in the buffer tank 664 to the fuel electrode 662, since the content of the alcohol in the fuel 124 is generally lower (by mole ratio) than the content of water (by mole ratio), the alcohol in the fuel 124 is consumed to gradually decrease the alcohol concentration in the fuel 124 in the buffer tank 664. With the structure shown in FIG. 5, when the alcohol concentration in the fuel 124 in the buffer tank 664 is decreased to a predetermined concentration or lower, the alarm reporting unit 680 is operated to generate an alarm, so that the termination of the use of the fuel 124 in the buffer tank 664 can be detected.

FIG. 6 is a drawing showing the structure of the concentration measurement unit 670 in detail.

The concentration measurement unit 670 includes a resistance measuring unit (R/O) 682 for measuring the resistance value between the first electrode terminal 666 and the second electrode terminal 667, a concentration calculation unit (S/O) 684 for calculating the alcohol concentration in the buffer tank 664 based on the resistance value measured by the resistance measuring unit 682, and a reference data storing unit 685 for storing reference data showing the correlation between the resistance value between the first electrode terminal 666 and the second electrode terminal 667, and the methanol concentration. For the resistance measuring unit 682, an alternating current impedance meter provided with a bridge may be employed. The resistance value of the first electrode terminal 666 and the second electrode terminal 667 may be measured by using an alternating current with low amplitude of 20 mV or lower. The concentration calculation unit 684 refers to the reference data storing unit 685 and calculates the methanol concentration from the resistance value measured by the concentration calculation unit 684 based on the reference data.

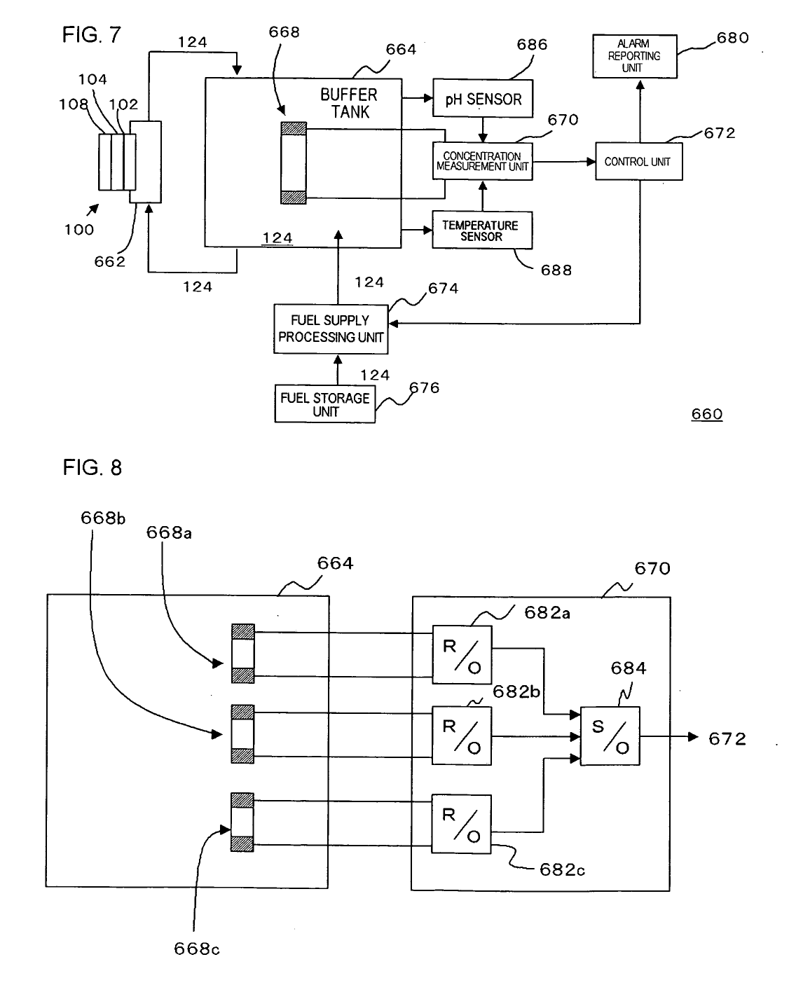

Also, as shown in FIG. 7, the fuel cell system 660 may further include a pH sensor 686 and a temperature sensor 688. As shown in the above-mentioned formula (2), carbon dioxide is generated at the fuel electrode 102. Therefore, when passing the fuel electrode tank 662, carbon dioxide is dissolved in the fuel 124 and pH of the fuel 124 may be changed. Since the proton conductivity of the polymer membrane 665 may depend on temperature or pH, the concentration measurement unit 670 is preferable to measure the methanol concentration in the fuel 124 in consideration of the temperature and pH of the fuel 124. The pH sensor 686 and the temperature sensor 688 respectively measure the pH and temperature of the fuel 124 in the buffer tank 664. The reference data storing unit 685 (FIG. 6) may store the correlation between the resistance value between the first electrode terminal 666 and the second electrode terminal 667, and the methanol concentration for respective temperature value and pH value. Further, the reference data storing unit 685 may store the correction formula for the correlation between the resistance value between the first electrode terminal 666 and the second electrode terminal 667, and the methanol concentration for respective temperature value and pH value. In such a manner, the concentration measurement unit 670 can measure the methanol concentration in the fuel 124 in consideration of the temperature and pH of the fuel 124 in the buffer tank 664 and thus accurately measure the methanol concentration.

In the case when the pH sensor 686 is not included in the fuel cell system 660, the reference data storing unit 685 (FIG. 6) may store the correlation between the resistance value between the first electrode terminal 666 and the second electrode terminal 667, and the methanol concentration in the state where the fuel 124 is saturated with carbon dioxide gas. In this case, the measurement of the alcohol concentration by the concentration measurement unit 670 may be started after the fuel 124 in the buffer tank 664 is saturated with carbon dioxide gas. In such a manner, the alcohol concentration in the fuel 124 can be measured without considering the pH alteration in the fuel 124 due to the carbon dioxide generation in the electrode reaction of the fuel cell main body 100.

A thermocouple, a metal temperature measuring resistor, a thermistor, an IC temperature sensor, a magnetic temperature sensor, a thermopile, or a pyroelectric type temperature sensor may be employed as the temperature sensor 688. Also, commercially available pH meters may be employed as the pH sensor 686. When the pH meter having a temperature measuring function is used, the pH sensor 686 and the temperature sensor 688 may be united in a single body.

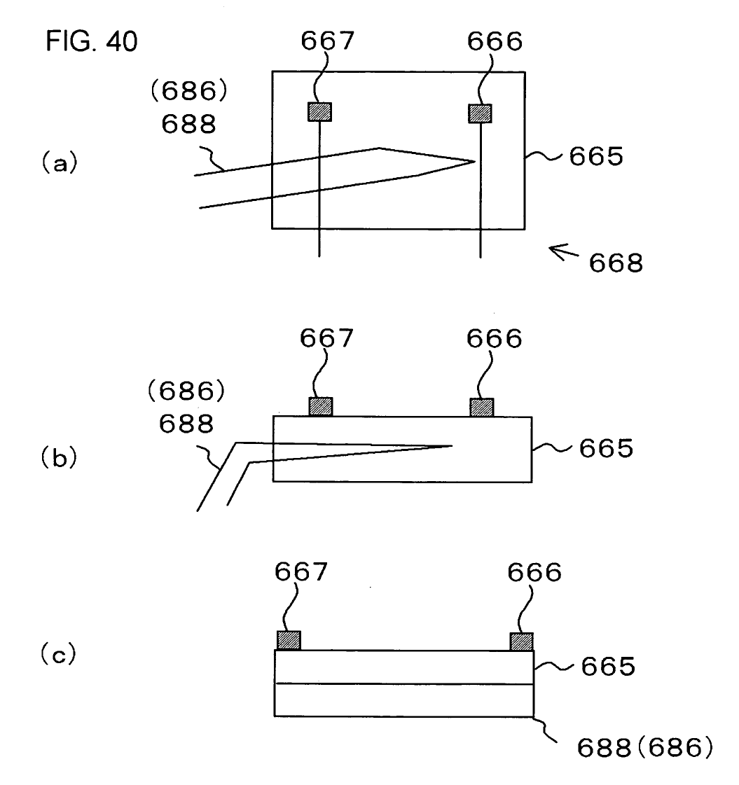

FIG. 40 shows the structure in which the temperature sensor 688 (or the pH sensor 686) and the sensor 668 are united in a single body. As shown in FIG. 40(a), the sensor 668 may be composed by stacking the temperature sensor 688 (or the pH sensor 686) to the surface of the polymer membrane 665 and also, as shown in FIG. 40(b), the sensor 668 may be composed by embedding the temperature sensor 688 in the polymer membrane 665. Further, the sensor 668 may be composed, as shown in FIG. 40(c), by sticking a film-like concentration measurement unit 670 to the polymer membrane 665.

Further, as shown in FIG. 8, the alcohol concentration, temperature, and pH of the fuel 124 in the buffer tank 664 may be measured by employing a plurality of sensors 668a, 668b, and 668c each including three or more kinds of polymer membranes with different proton conductivities depending on the temperature and pH in combination. As such combinations of the polymer membranes, for example, (1) sulfonic acid group-containing polyperfluorocarbons such as Nafion, (2) sulfonic acid group-containing polyether ketones such as polyether ether ketones (PEEK), and (3) sulfonic acid group-containing polystyrene copolymers may be employed. In this case, the concentration measurement unit 670 may include a plurality of resistance measurement units 682a, 682b, and 682c for respectively measuring the resistance values in the sensors 668a, 668b, and 668c. The concentration calculation unit 684 may detect the alcohol concentration in the fuel 124 based on the resistance values measured by the plurality of resistance measuring units 682a, 682b, and 682c in consideration of the temperature and pH.

Further, as shown in FIG. 7, the alcohol concentration and pH in the fuel 124 in the buffer tank 664 may be measured by employing the temperature sensor 688 in combination with two or more kinds of polymer membranes with different proton conductivities depending on pH.

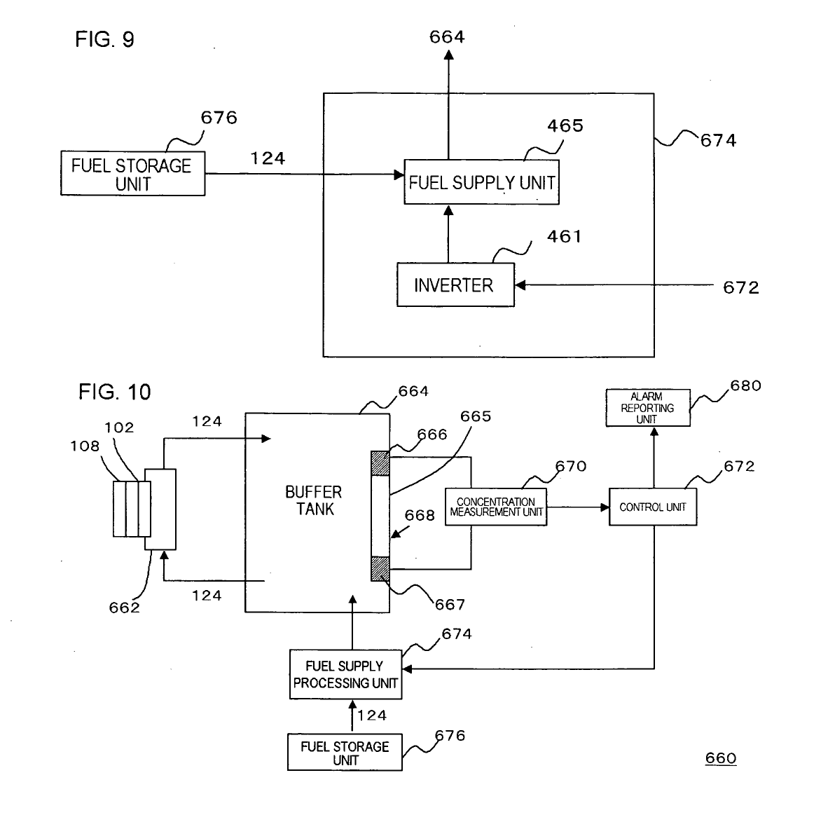

FIG. 9 is a drawing showing the structure of the fuel supply processing unit 674 in detail.

The fuel supply processing unit 674 includes an inverter 461 and a fuel supply unit 465. The fuel supply unit 465 changes the supply amount of the fuel 124 supplied to the buffer tank 664 from the fuel storage unit 676. As the fuel supply unit 465, a piezoelectric pump may be used. When the piezoelectric pump is used as the fuel supply unit 465, the control unit 672 controls the supply amount of the fuel 124 from the fuel storage unit 676 by changing the frequency or voltage of the inverter 461.

As compared with the case of using a conventional electromagnetic pump, use of the piezoelectric pump as the fuel supply unit 465 makes it possible to miniaturize the pump and to make the weight of the pump light. Also, the durability is improved. The electric power necessary for operating the pump can be reduced as well. Further, the supply amount of the fuel 124 from the pump can be controlled well by changing the frequency or voltage in the inverter 461. When the frequency of the inverter 461 is changed, the discharge frequency of the pump per unit time can be changed. Further, when the voltage is changed, the discharge amount per one discharge operation can be changed by alteration of the displacement degree of a piezoelectric element. Accordingly, the supply amount of the fuel 124 can be adjusted in any case that either one is changed.

As the piezoelectric pump, for example, a bimorph type piezoelectric pump is preferable to be employed. As the bimorph type piezoelectric pump a Bimorph Pump (registered trademark; manufactured by Kyokko Co.) and a bimorph type piezoelectric device manufactured by FDK Co may be employed. Although not shown in the drawings, the inverter 461 may obtain an operation power source for the bimorph type piezoelectric pump by ac/dc conversion of the output from the fuel cell main body 100. As the inverter 461, a series of EXCF manufactured by Matsushita Electric Industrial Co., Ltd may be employed.

Although not shown in the drawings, the buffer tank 664 and the fuel electrode tank 662 may be composed in a structure in which the fuel 124 can be circulated via a piezoelectric pump having similar structure to that of the fuel supply unit 465. In such a manner, when the liquid fuel is used as the fuel 124, the gas such as carbon dioxide generated in the fuel electrode 102 can efficiently be removed from the fuel electrode 102. Consequently, the utilization factor of the catalyst in the fuel electrode 102 can be improved and the output of the fuel cell main body 100 can be improved.

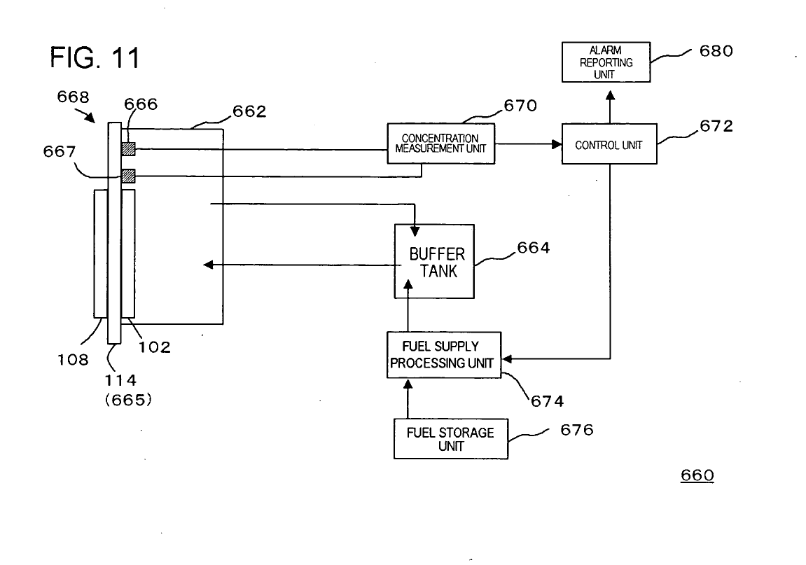

Also, as shown in FIG. 10, the sensor 668 may have a structure in which it is attached to the wall portion of the buffer tank 664. Further, as shown in FIG. 11, the sensor 668 may be placed in the fuel electrode tank 662. In this case, a portion of the solid electrolyte membrane 114 of the fuel cell main body 100 may be used as the polymer membrane 665 shown in FIG. 1.

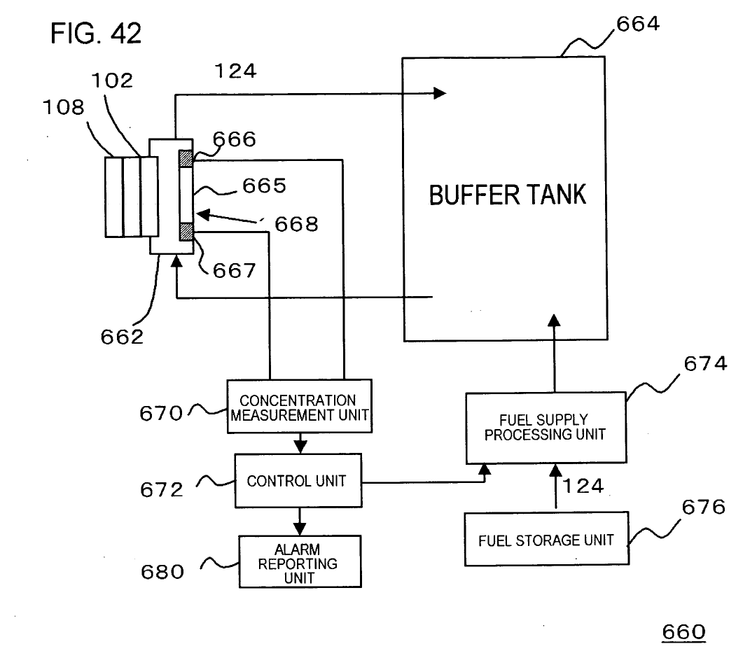

Also, as shown in FIG. 42, the sensor 668 may be attached to a wall portion of the fuel electrode tank 662. Further, although not shown in the drawings, the sensor 668 may be placed in the fuel electrode tank 662.

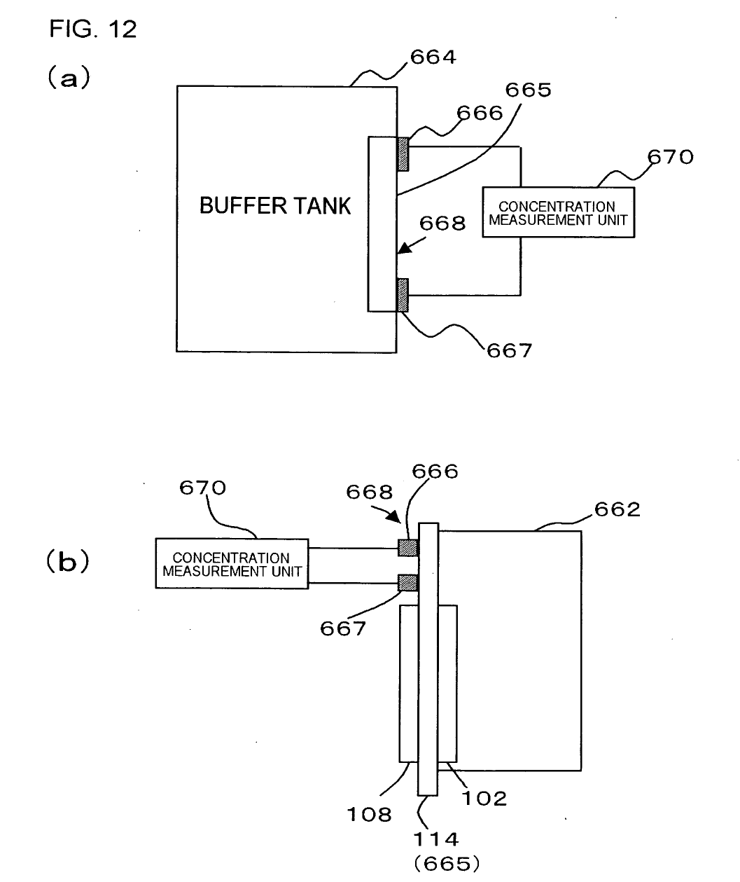

FIG. 12 shows a modified example of the sensor 668 having the structure shown in FIG. 10 and FIG. 11. FIG. 12(a) shows a modified example of the sensor 668 shown in FIG. 10. As for the sensor 668, the first electrode terminal 666 and the second electrode terminal 667 may be attached at the outside of the buffer tank 664 so as to have them not directly contact with fuel in the buffer tank 664. If the polymer membrane 665 is impregnated with the fuel in the buffer tank 664, even if the first electrode terminal 666 and the second electrode terminal 667 are not placed in the buffer tank 664, the resistance value between the first electrode terminal 666 and the second electrode terminal 667 can be detected. With such a structure, since the first electrode terminal 666 and the second electrode terminal 667 are not constantly placed in the fuel, the first electrode terminal 666 and the second electrode terminal 667 are prevented from corrosion by the fuel. Accordingly, the first electrode terminal 666 and the second electrode terminal 667 can be stably maintained.

FIG. 12(b) shows a modified example of the sensor 668 shown in FIG. 11. Here, as for the sensor 668, the first electrode terminal 666 and the second electrode terminal 667 may be attached to the oxidant electrode 108 side of the solid electrolyte membrane 114 so as not to directly contact the fuel in the fuel electrode tank 662. Accordingly, the first electrode terminal 666 and the second electrode terminal 667 can be stably maintained.

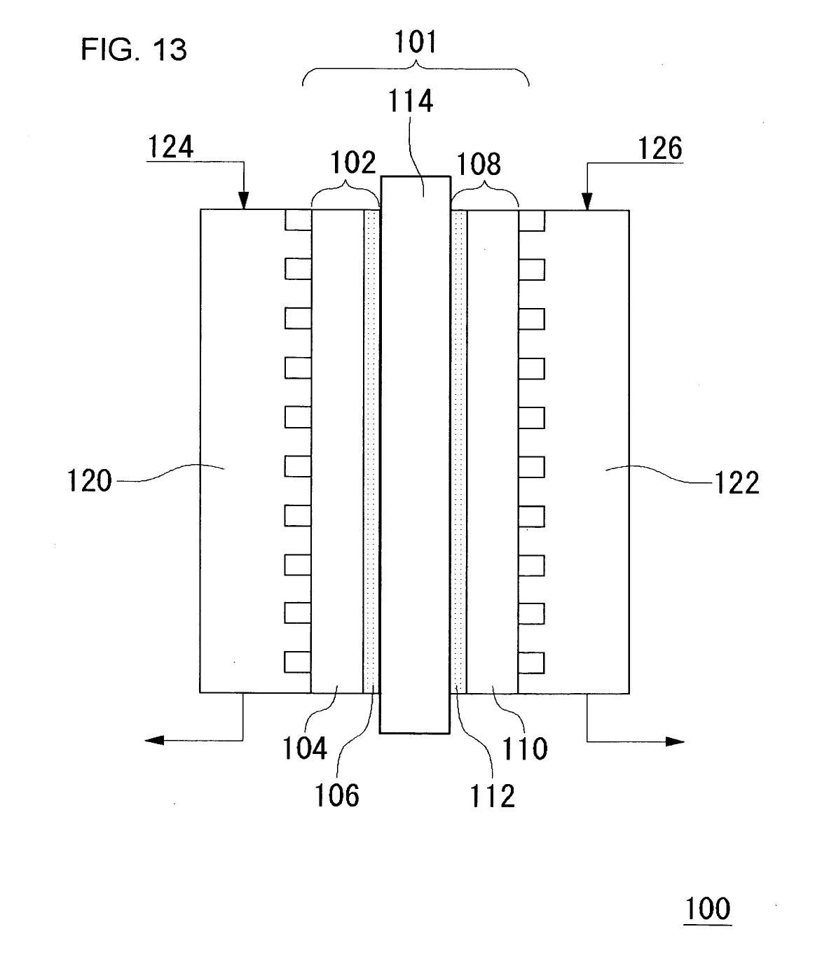

Next, with reference to FIG. 13, the structure of the fuel cell main body 100 shown in FIG. 1 will be described. The fuel cell main body 100 has a single or a plurality of unit cell(s) 101. FIG. 13 is a cross-sectional view schematically showing the unit cell 101. Each unit cell 101 includes the fuel electrode 102, the oxidant electrode 108, and the solid electrolyte membrane 114. In the fuel cell main body 100, the fuel 124 is supplied via the fuel electrode side separator 120 to the fuel electrode 102. Also, an oxidant 126 is supplied via an oxidant electrode side separator 122 to the oxidant electrode 108 of each unit cell 101.

The solid electrolyte membrane 114 has a function of transferring hydrogen ion (proton) between them in addition to separating the fuel electrode 102 and the oxidant electrode 108. Therefore, the solid electrolyte membrane 114 may preferably be a membrane having a high proton conductivity. Further, the membrane may preferably be chemically stable and may have high mechanical strength.

The fuel electrode 102 and the oxidant electrode 108 may respectively have a structure in which a fuel electrode side catalyst layer 106 and an oxidant electrode side catalyst layer 112 each containing catalyst-supporting carbon particles and solid polymer electrolyte fine particles is formed on a base member 104 and a base member 110, respectively. As the catalyst, platinum and alloys of platinum and ruthenium may be exemplified. The catalysts for the fuel electrode 102 and the oxidant electrode 108 may be same or different. When the fuel cell system 660 have the structure shown in FIG. 11, the region in the solid electrolyte membrane 114 where the fuel electrode side catalyst layer 106 and the oxidant electrode side catalyst layer 112 are not formed is used as the polymer membrane 665.

The surfaces of the base member 104 and the base member 110 may be subjected to water-repellent treatment. As described above, when methanol is used as the fuel 124, carbon dioxide is generated at the fuel electrode 102. If the bubbles of carbon dioxide generated at the fuel electrode 102 stagnate in the vicinity of the fuel electrode 102, supply of fuel 124 to the fuel 124 is inhibited to result in decrease of power generation efficiency. Therefore, it is preferable to carry out surface treatment to the surface of the base member 104 with a hydrophilic coating material or a hydrophobic coating material. The fluidity of the fuel at the surface of the base member 104 can be increased by the surface treatment with the hydrophilic coating material. Accordingly, the bubbles of carbon dioxide easily move together with the fuel 124. Also, water adhesion, which is a cause of bubble formation, to the surface of the base member 104 can be lessened by treatment with the hydrophobic coating material. Accordingly, the bubble formation on the surface of the base member 104 can be lessened. Further, owing to the synergetic effects of the surface treatment by the above-mentioned surface treatment manners and vibration treatment to the fuel cell main body 100, carbon dioxide can further efficiently removed form the fuel electrode 102, so that high electric power generation efficiency can be achieved. Titanium oxide, silicon oxide and the like may be exemplified as the hydrophilic coating material. On the other hand, polytetrafluoroethylene, silane and the like may be exemplified as the hydrophobic coating material.

The unit cell 101 having the above-mentioned structure is stacked so as to obtain the fuel cell main body 100 including a fuel cell stack where a plurality of unit cells 101 are connected in series.

According to the fuel cell system 660 of this embodiment, the alcohol concentration of a liquid fuel can be detected with a simple structure composed by attaching the first electrode terminal 666 and the second electrode terminal 667 to the polymer membrane 665.

(Second Embodiment)

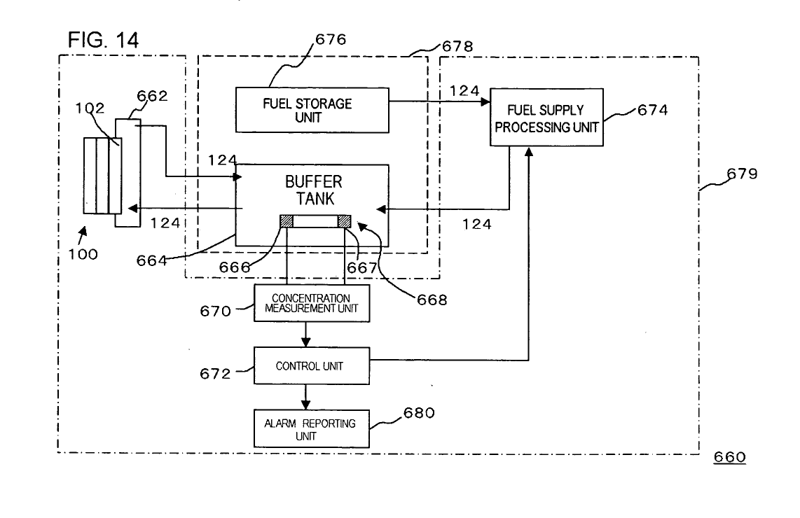

FIG. 14 is a drawing showing one example of the structure of a fuel cell system of the second embodiment of the invention. In this embodiment, a cartridge 678 is attached to the fuel cell system 660.

The cartridge 678 includes a buffer tank 664 and a fuel storage unit 676. The main body side 679 of the fuel cell system 660 includes the fuel cell main body 100, the fuel electrode tank 662, the fuel supply processing unit 674 the concentration measurement unit 670, and the control unit 672. Same symbols are assigned to the element components same as those explained in the first embodiment with FIG. 1, and the explanation to them will properly be omitted.

Here, the fuel supply processing unit 674 is composed so as to supply the fuel 124 contained in the fuel storage unit 676 of the cartridge 678 to the buffer tank 664 when the cartridge 678 is attached. In the cartridge 678, the buffer tank 664 contains a sensor 668. The main body side 679 includes terminals (not shown in the drawing) to be electrically connected with the first electrode terminal 666 and the second electrode terminal 667 of the sensor 668 when the cartridge 678 is attached to the concentration measurement unit 670. The fuel electrode tank 662 is composed so as to introduce the fuel 124 from the buffer tank 664.

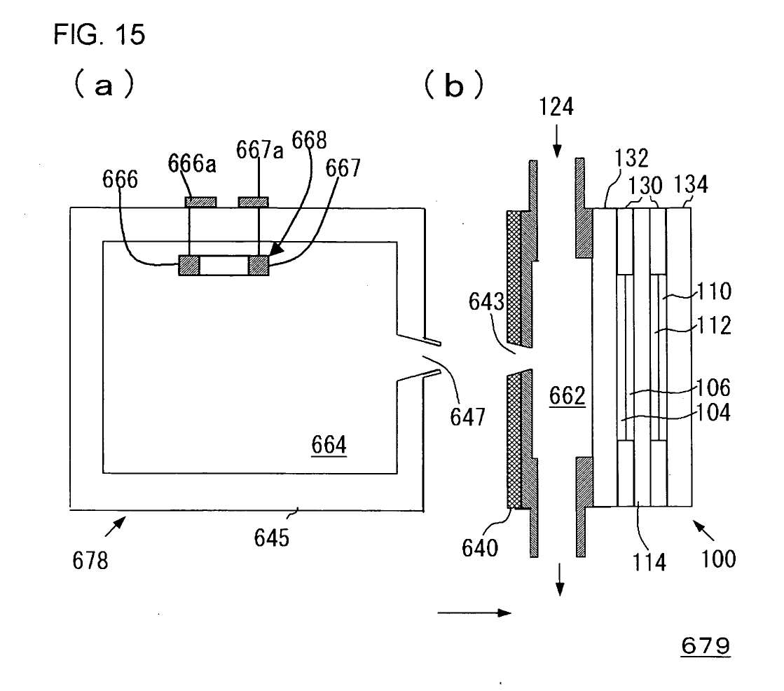

FIG. 15 is a schematic drawing showing the buffer tank 664 in the cartridge 678 and the fuel electrode tank 662 in the main body side 679. A fuel supply port 643 is provided in the fuel electrode tank 662 and the buffer tank 664 has a fitting unit 647 to be fitted with the fuel supply port 643 of the fuel electrode tank 662. An electrode terminal 666a and an electrode terminal 667a electrically connected with the first electrode terminal 666 and the second electrode terminal 667 of the sensor 668 respectively are provided at a side wall of the cartridge main body 645. Herein, the fuel cell main body 100 further includes an insulating sheet 130, a fuel electrode side collector 132, and an oxidant electrode side collector 134 in addition to the structure shown in FIG. 14.

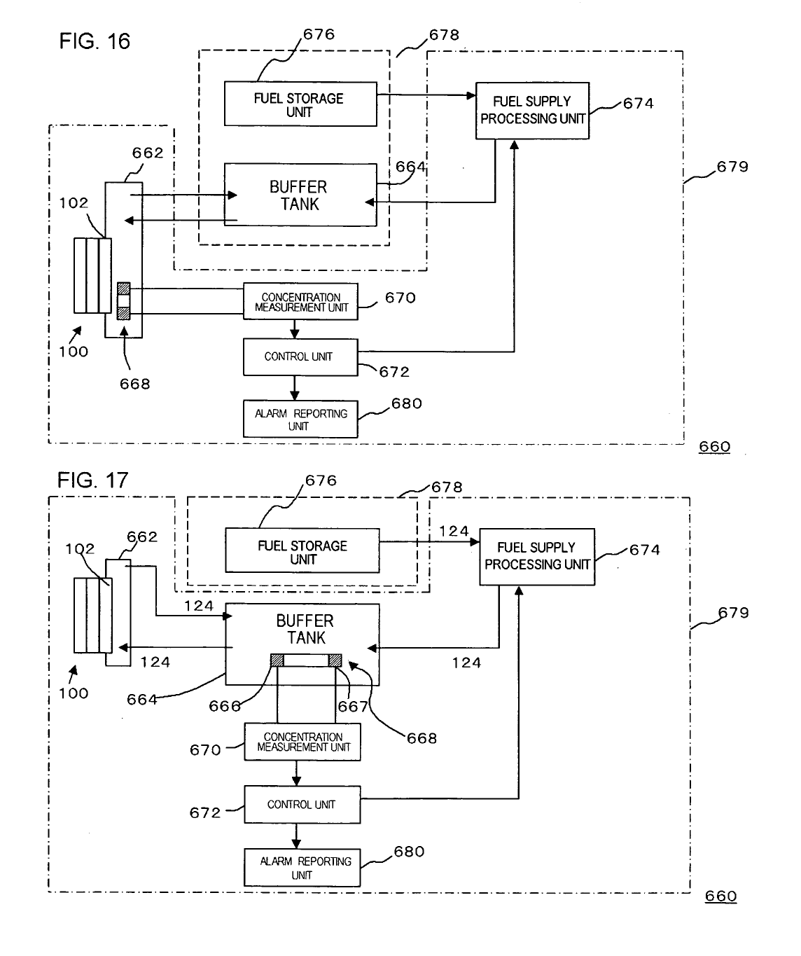

As shown in FIG. 16, the sensor 668 may be provided in the fuel electrode tank 662 of the main body side 679. Further, as shown in FIG. 17, the fuel cell system 660 may be composed so as to make the cartridge 678 containing only the fuel storage unit 676 detachable thereto. Also, although not shown in the drawings, the cartridge 678 may include a valve. The sensor 668 may be attached at a wall portion of the cartridge 678. In this case, the cartridge 678 is made to have a structure in which exposed portion of the sensor 668 exposed at the outside is coated with a seal and the seal is removed before attaching it to the main body side 679. Consequently, leakage of liquid fuel from the cartridge 678 before attaching the cartridge 678 to the main body side 679 can be prevented.

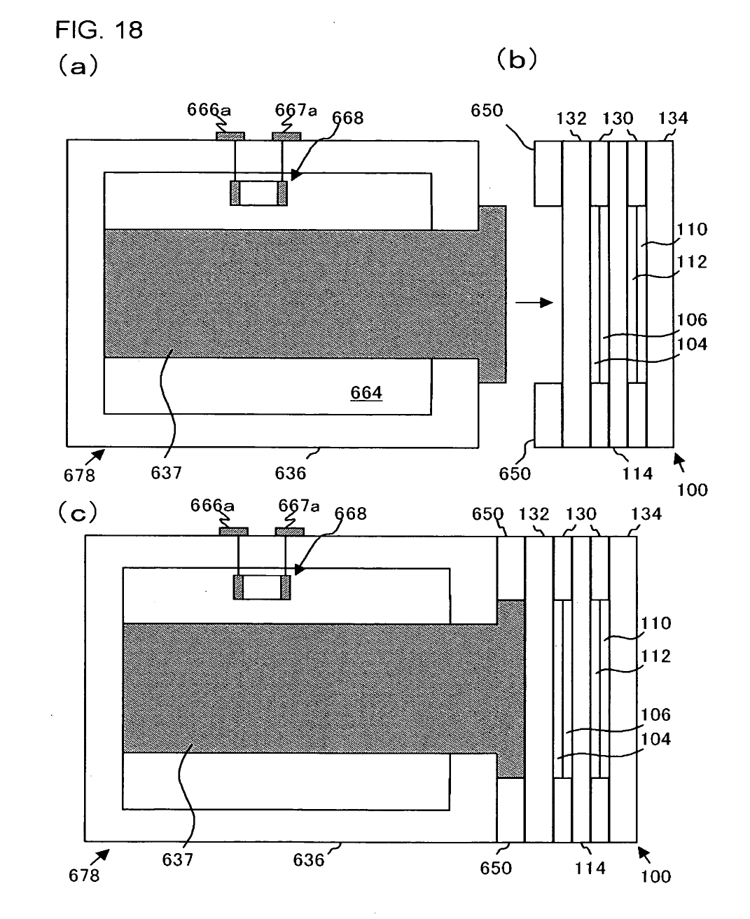

FIG. 18 is a drawing showing another example of the cartridge 678 shown in FIG. 15. Here, the buffer tank 664 of the cartridge 678 contains a fuel supply member 637. In this example, the fuel cell main body 100 does not include the fuel electrode tank 662 and the fuel contained in the buffer tank 664 is supplied to the fuel electrode 102 of the fuel cell main body 100 via the fuel supply member 637. The fuel supply member 637 is made of a material capable of absorbing the fuel 124 and supplying the absorbed fuel to the fuel cell main body 100. The fuel supply member 637 may be, for example, made of an urethane. Further, the fuel supply member 637 may be made of ceramic porous bodies such as a silica porous body and an alumina porous body; and porous films of fluoro resin, polyethylene, polypropylene, polycarbonate, polyimide, polysulfone, polysulfide, and polybenzimidazole.

When the cartridge 678 has such a structure, the control unit 672 may make an alarm reporting unit 680 generate an alarm if the alcohol concentration in the buffer tank 664 measured by the concentration measurement unit 670 is not within the proper range.

According to the fuel cell system 660 of this embodiment, the alcohol concentration of the liquid fuel can be detected with a simple structure.

### EXAMPLE 1

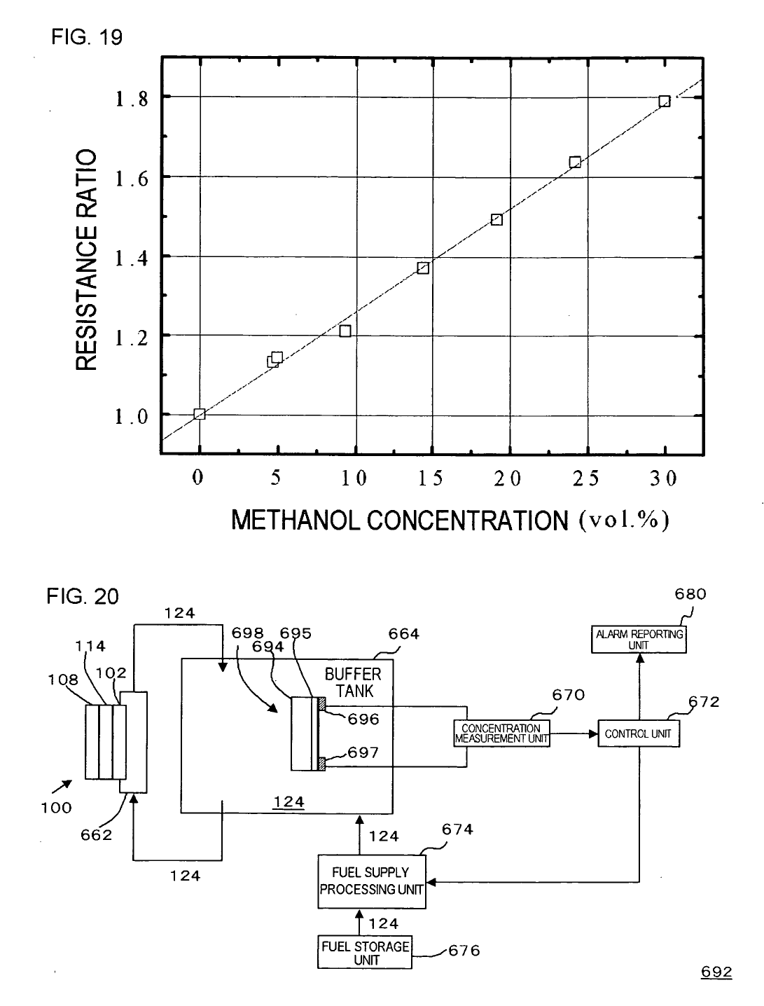

A Nafion N112 membrane (manufactured by E.I. du Pont de Nemours and Co., thickness of which is about 50 μm, width of which is about 5 mm, and length of which is about 60 mm) was used as a polymer membrane 665 and gold terminals (width of which is about 6 mm square) were attached to both ends in the longitudinal direction of the polymer membrane 665 to provide the sensor 668. An aqueous methanol solution with a known concentration was introduced into a container and the resistance value between the electrodes was measured by alternating current with low amplitude of 10 mV or lower, by employing an alternating current impedance meter provided with a bridge. FIG. 19 shows the correlation between the methanol concentration and the resistance value. As described, the alcohol concentration could accurately be detected by utilizing the alteration of the proton conductivity of the polymer membrane 665.

(Third Embodiment)

FIG. 20 is a drawing showing one example of the structure of a fuel cell system of the third embodiment of the invention. The fuel cell system 692 shown in FIG. 20 includes a fuel cell main body 100, a fuel electrode tank 662, a buffer tank 664, a sensor 698, a concentration measurement unit 670, a control unit 672, a fuel supply processing unit 674 a fuel storage unit 676, and an alarm reporting unit 680.

In this embodiment, as fuel 124, organic liquid fuel such as methanol, ethanol, dimethyl ether, or other alcohols may be used. The organic liquid fuel may be in form of an aqueous solution.

The fuel cell main body 100 includes a solid electrolyte membrane 114, and a fuel electrode 102 and an oxidant electrode 108 attached to the solid electrolyte membrane 114. As the oxidant to be supplied to the oxidant electrode 108, air is generally used, or oxygen gas may be supplied. The fuel cell main body 100 has the same structure as described with reference to FIG. 13 in the first embodiment.

In this embodiment, the fuel storage unit 676 contains fuel 124 with a higher alcohol concentration than that of the fuel 124 to be supplied to the fuel electrode 102.

The fuel 124 to be supplied to the fuel electrode 662 is introduced into the buffer tank 664. The sensor 698 is used for detecting the alcohol concentration in the fuel 124 in the buffer tank 664. The sensor 698 includes a polymer membrane 694, a strain gauge 695, a first terminal 696, and a second terminal 697. The polymer membrane 694 is structured to be impregnated with alcohol and made of a material whose size is changeable depending on the alcohol concentration of the fuel 124. The fuel cell system 692 of this embodiment can detect the methanol concentration in the fuel 124 in the buffer tank 664 based on the degree of the size alteration of the polymer membrane 694.

The polymer membrane 694 is made of any material provided that the size of the material is changeable depending on the alcohol concentration of the fuel 124. For example, it may be made of the material same as that of the solid electrolyte membrane 114. Typical examples of the favorable materials include organic polymers having a polar group such as a strong acid group such as sulfone group, phosphorus acid group, phosphonic group, and phosphine group or a weak acid group such as carboxyl group. Typical examples of such the organic polymers include:

aromatic group-containing polymers such as sulfonated poly(4-phenoxybenzoyl-1,4-phenylene) and alkyl-sulfonated polybenzoimidazole;

copolymers such as polystyrenesulfonic acid copolymers, polyvinylsulfonic acid copolymers, crosslinked alkylsulfonic acid derivatives, and copolymers of fluorine-containing polymers having a fluoroplastic structure and a sulfonic acid;

copolymers of an acrylamide such as acrylamide-2-methylpropanesulfonic acid and an acrylate such as n-butyl methacrylate;

sulfonic acid group-containing perfluorocarbons (Nafion (registered trademark; manufactured by E.I. du Pont de Nemours and Company), Aciplex (manufactured by Asahi Kasei Corp.));

carboxyl group-containing perfluorocarbon (Flemion (registered trademark) S film (manufactured by Asahi Glass Co., LTD.));

aromatic polyether, polyphenylene sulfide, polyimide, polyphosphazene, trifluorostyrene copolymer (BAM3G, manufactured by Ballard Advanced Materials Corporation) and the like.

The polymers exemplified above further substituted with a crosslinkable substituent group such as a vinyl group, an epoxy group, an acryl group, a methacryl group, a cinnamoyl group, a methylol group, an azide group, or a naphthoquinonediazide group may be used as they are or after being crosslinked by irradiating radiation, ultraviolet, electron ray or the like in the molten state.

Also, the membrane may be made of any polymers, even materials which do not include polar groups, provided that the size of which is changeable depending on the alcohol concentration of the fuel 124.

The strain gauge 695 is stuck to the surface of the polymer membrane 694 or embedded in the inside thereof. The strain gauge 695 may be composed unitedly with the polymer membrane 694. The strain gauge 695 may have any structure and for example, a Wheatstone bridge circuit may be composed by four strain gauges and the resistance alteration of the strain gauges owing to the strain may be outputted as electric signals from the first terminal 696 and the second terminal 697. The concentration measurement unit 670 measures the alcohol concentration of the fuel 124 in the buffer tank 664 based on the resistance value between the first terminal 696 and the second terminal 697. The detailed structure of the concentration measurement unit 670 will be described later.

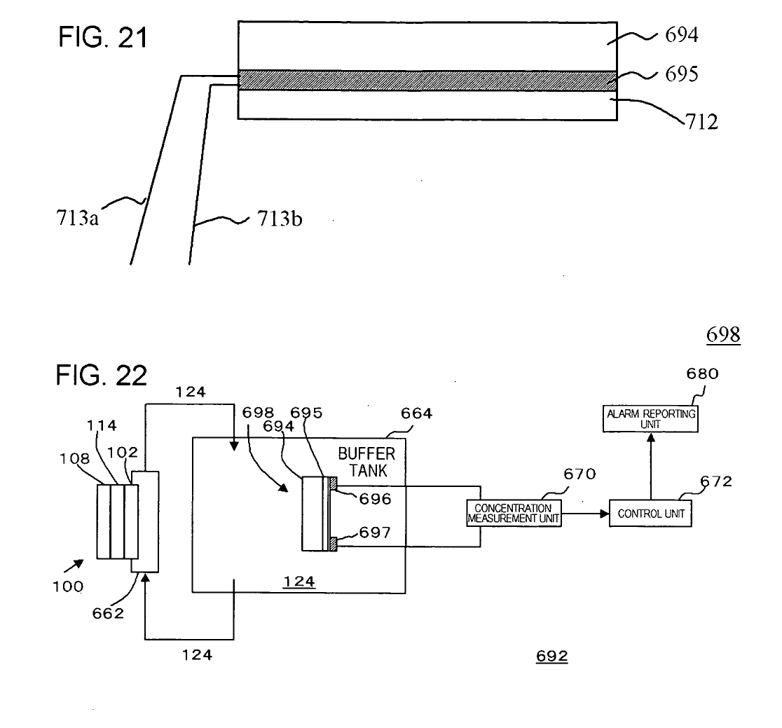

FIG. 21 is a drawing showing the sensor 698 in detail. The sensor 698 includes the polymer membrane 694 and the strain gauge 695 attached at the polymer membrane 694 and the surface of the strain gauge 695 may be covered with a water-proof film 712. The electric signals from the strain gauge 695 are transmitted through wiring 713a and wiring 713b.

Referring back to FIG. 20, the alcohol concentration of the fuel 124 in the buffer tank 664 measured by the concentration measurement unit 670 is transmitted to the control unit 672. The fuel supply processing unit 674 carries out the process for supplying the fuel 124 to the buffer tank 664 from the fuel storage unit 676. The control unit 672 determines whether the alcohol concentration measured by the concentration measurement unit 670 is within a proper range or not and controls the fuel supply processing unit 674 so as to have the alcohol concentration of the fuel 124 in the buffer tank 664 within a proper range. The fuel supply processing unit 674 controls the supply amount of the fuel 124 to be supplied to the buffer tank 664 from the fuel storage unit 676 based on the control of the control unit 672. The detailed structure of the fuel supply processing unit 674 will also be described later.

[125]

The control unit 672 makes the alarm reporting unit 680 generate an alarm in the case the alcohol concentration of the fuel 124 in the buffer tank 664 is not within the proper range even after repeating the control of the fuel supply processing unit 674.

As shown in FIG. 22, the fuel cell system 692 may not include the fuel storage unit 676 and the fuel supply processing unit 674. In this case, the control unit 672 makes the alarm reporting unit 680 generate an alarm in the case the alcohol concentration measured by the concentration measurement unit 670 is found not within the proper range. When electrochemical reaction is caused in the fuel cell main body 100 by circulating the fuel 124 of the buffer tank 664 to the fuel electrode 662, the alcohol in the fuel 124 is consumed to gradually decrease the alcohol concentration in the fuel 124 in the buffer tank 664. If the structure shown in FIG. 22 is employed, when the alcohol concentration in the fuel 124 in the buffer tank 664 is decreased to a predetermined concentration or lower, the alarm reporting unit 680 is operated to generate an alarm, so that the termination of the use of the fuel 124 in the buffer tank 664 can be detected.

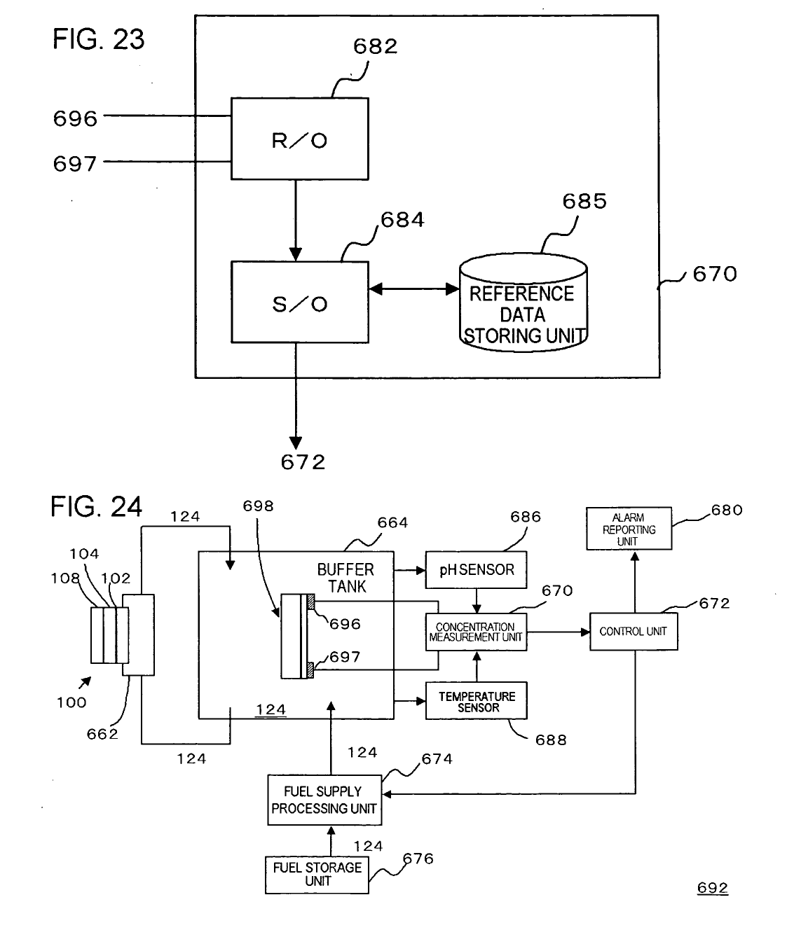

FIG. 23 is a drawing showing the structure of the concentration measurement unit 670 in detail.

The concentration measurement unit 670 includes a resistance measuring unit (R/O) 682 for measuring the resistance value between the first terminal 696 and the second terminal 697, a concentration calculation unit (S/O) 684 for calculating the alcohol concentration in the buffer tank 664 based on the resistance value measured by the resistance measuring unit 682, and a reference data storing unit 685 for storing reference data showing the correlation between the resistance value between the first electrode terminal 669 and the second electrode terminal 697, and the methanol concentration. For the resistance measuring unit 682, a direct current source meter provided with a bridge may be employed. The concentration calculation unit 684 refers to the reference data storing unit 685 and calculates the methanol concentration from the resistance value measured by the concentration calculation unit 684 based on the reference data.

As shown in FIG. 24, the fuel cell system 692 may further include a pH sensor 686 and a temperature sensor 688. The pH sensor 686 and the temperature sensor 688 measure the pH and temperature of the fuel 124 in the buffer tank 664, respectively. The reference data storing unit 685 may store the correlation between the resistance value between the first terminal 696 and the second terminal 697, and the methanol concentration for respective temperature value and pH value. Further, the reference data storing unit 685 may store the correction formula for the correlation of the between the resistance value between the first electrode terminal 666 and the second electrode terminal 667, and the methanol concentration for respective temperature value and pH value. In such a manner, the concentration measurement unit 670 can measure the methanol concentration in the fuel 124 in consideration of the temperature and pH of the fuel 124 in the buffer tank 664 and thus accurately measure the methanol concentration.

A thermocouple, a metal temperature measuring resistor, a thermistor, an IC temperature sensor, a magnetic temperature sensor, a thermopile, or a pyroelectric type temperature sensor may be employed as the temperature sensor 688. Also, commercially available pH meters may be employed as the pH sensor 686. When the pH meter having a temperature measuring function is used, the pH sensor 686 and the temperature sensor 688 may be united in a single body.

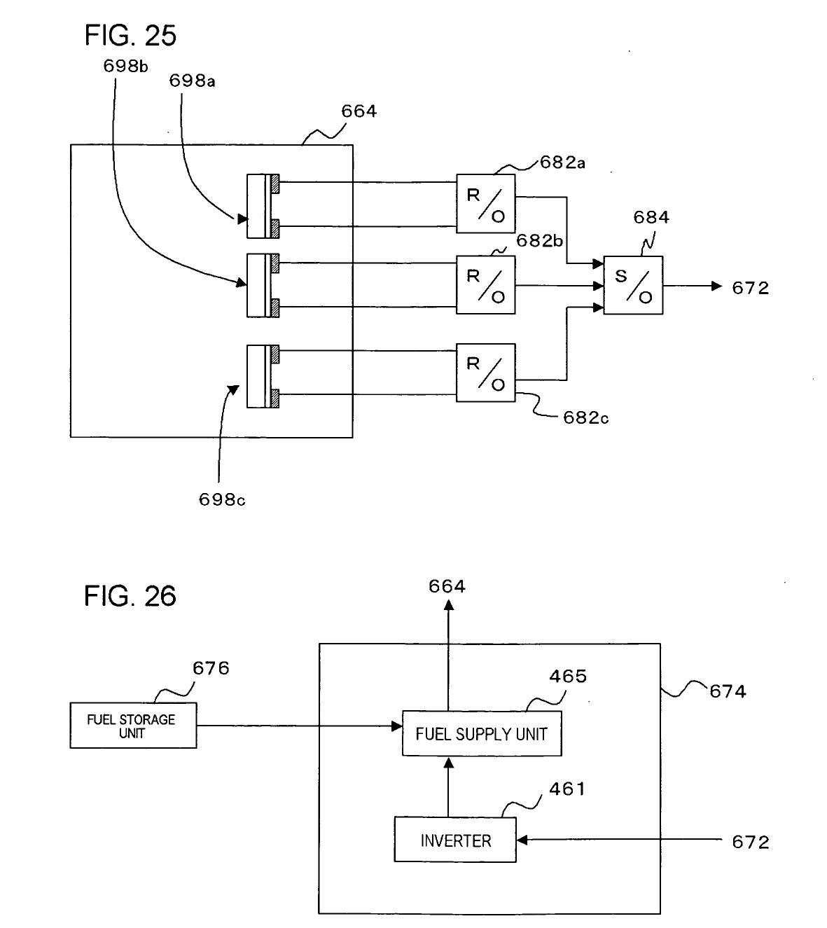

Further, as shown in FIG. 25, the alcohol concentration, the temperature, and pH in the fuel 124 in the buffer tank 664 may be measured by employing a plurality of sensors 698a, 698b, and 698c, in combination, each including three or more kinds of polymer membranes with different proton conductivities depending on the temperature and pH. As such combinations of the polymer membranes, for example, (1) polyperfluorocarbons containing sulfonic acid groups such as Nafion, (2) polyether ketones containing sulfonic acid groups such as PEEK, and (3) sulfonic acid group-containing polystyrene copolymers may be employed. In this case, the concentration measurement unit 670 may include a plurality of resistance measurement units 682a, 682b, and 682c for measuring the resistance values in the of the polymer membranes 698a, 698b, and 698c, respectively. The concentration calculation unit 684 may detect the alcohol concentration in the fuel 124 based on the resistance values measured by the plurality of resistance measuring units 682a, 682b, and 682c in consideration of the temperature and pH.

Further, as shown in FIG. 25, the temperature sensor 688 may be used with two or more kinds of polymer membranes with different electric conductivities depending on pH in combination so as to measure the alcohol concentration and pH in the fuel 124 in the buffer tank 664.

FIG. 26 is a drawing showing the structure of fuel supply processing unit 674 in detail.

The fuel supply processing unit 674 includes an inverter 461 and a fuel supply unit 465. The fuel supply unit 465 changes the supply amount of the fuel 124 to the buffer tank 664 from the fuel storage unit 676. As the fuel supply unit 465, a piezoelectric pump may be used. When the piezoelectric pump is used as the fuel supply unit 465, the control unit 672 controls the supply amount of fuel 124 from the fuel storage unit 676 by changing the frequency or voltage in the inverter 461.

Also, although not shown in the drawing, the buffer tank 664 and the fuel electrode tank 662 may be composed in a structure that the fuel 124 can be circulated via a piezoelectric pump having a similar structure to that of the fuel supply unit 465. In such a manner, when the liquid fuel is used as the fuel 124, the gas such as carbon dioxide generated in the fuel electrode 102 can efficiently be removed from the fuel electrode 102. Consequently, the utilization factor of the catalyst in the fuel electrode 102 can be improved and the output of the fuel cell main body 100 can be improved.

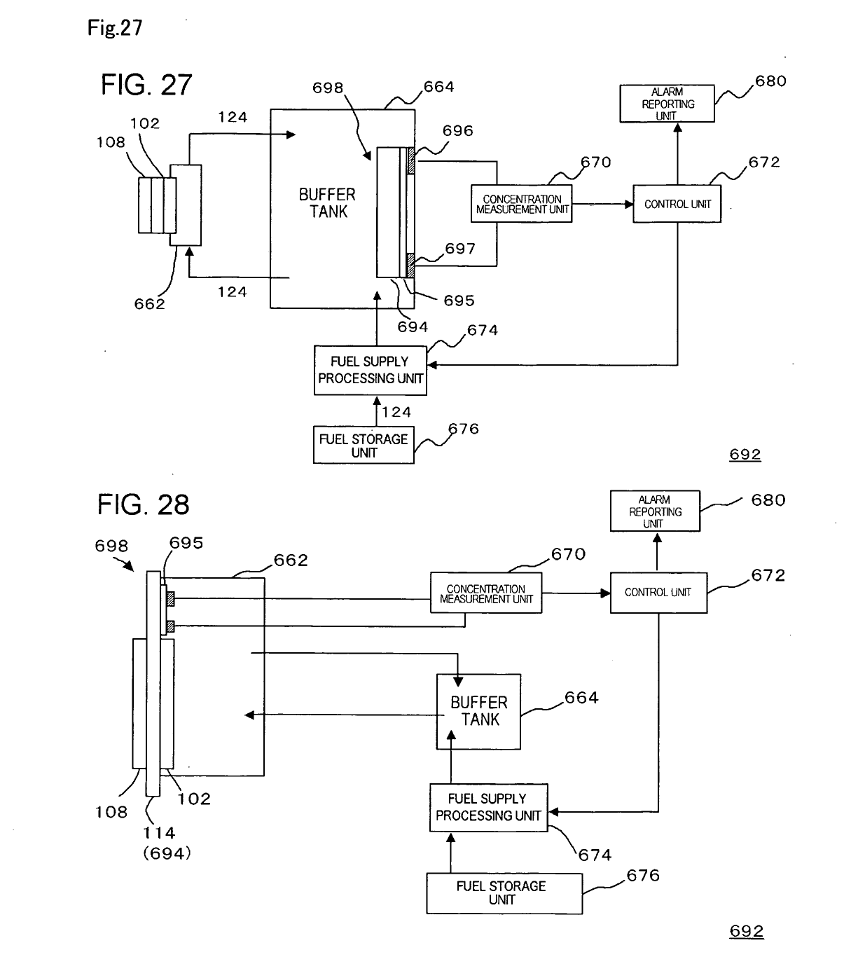

Also, as shown in FIG. 27, the sensor 698 may be attached at the wall portion of the buffer tank 664. Further, as shown in FIG. 28, the sensor 698 may be provided in the fuel electrode tank 662. In this case, a portion of the solid electrolyte membrane 114 of the fuel cell main body 100 may be used as the polymer membrane 694 shown in FIG. 20.

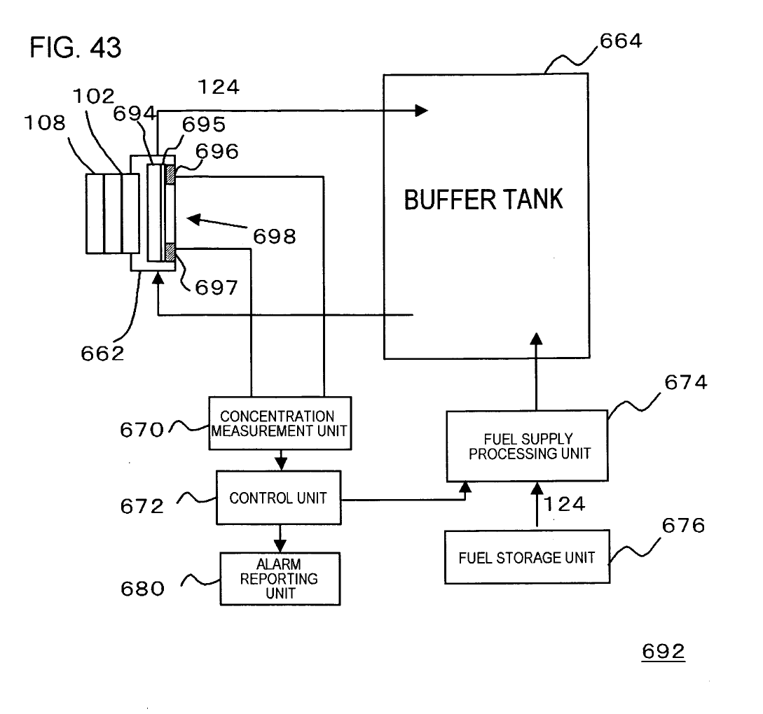

Also, as shown in FIG. 43, the sensor 698 may be attached at a wall portion of the fuel electrode tank 662. Further, although not shown in the drawings, the sensor 698 may be provided in the fuel electrode tank 662.

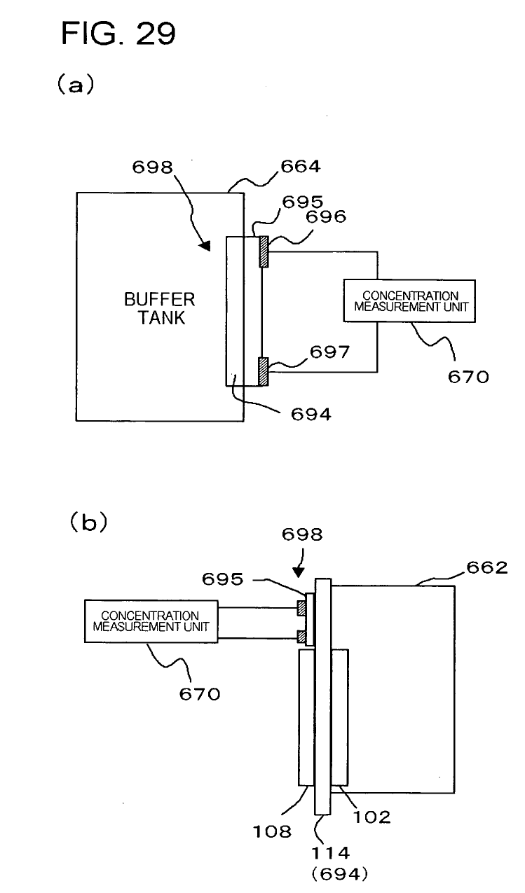

FIG. 29 shows a modified example of the sensor 698 shown in FIG. 27 and FIG. 28. FIG. 29(a) shows a modified example of the sensor 698 shown in FIG. 27. As for the sensor 698, the strain gauge 695, the first terminal 696 and the second terminal 697 may be attached at the outside of the buffer tank 664 so as not to directly contact with fuel in the buffer tank 664. If the polymer membrane 694 is impregnated with the fuel in the buffer tank 664, even if the strain gauge 695, the first terminal 696 and the second terminal 697 are not provided in the buffer tank 664, the resistance value between the first terminal 696 and the second terminal 697 can be detected. With such a structure, the strain gauge 695 may be composed without the water-proof film 712 as shown in FIG. 21. Also, owing to such a structure, since the first terminal 696 and the second terminal 697 are not constantly provided in the fuel, the first terminal 696 and the second terminal 697 are prevented from corrosion by the fuel. Accordingly, the first terminal 696 and the second terminal 697 can be stably maintained.

FIG. 29(b) shows a modified example of the sensor 698 shown in FIG. 28. Here, the strain gauge 695, the first terminal 696, and the second terminal 697 may be attached at the oxidant electrode 108 side of the solid electrolyte membrane 114 so as not to directly contact with fuel in the fuel electrode tank 662. Accordingly, since the strain gauge 695, the first terminal 696 and the second terminal 697 are not constantly provided in the fuel, the strain gauge 695, the first terminal 696 and the second terminal 697 can be stably maintained.

According to the fuel cell system 692 in this embodiment, the alcohol concentration of the liquid fuel can be detected with a simple structure.

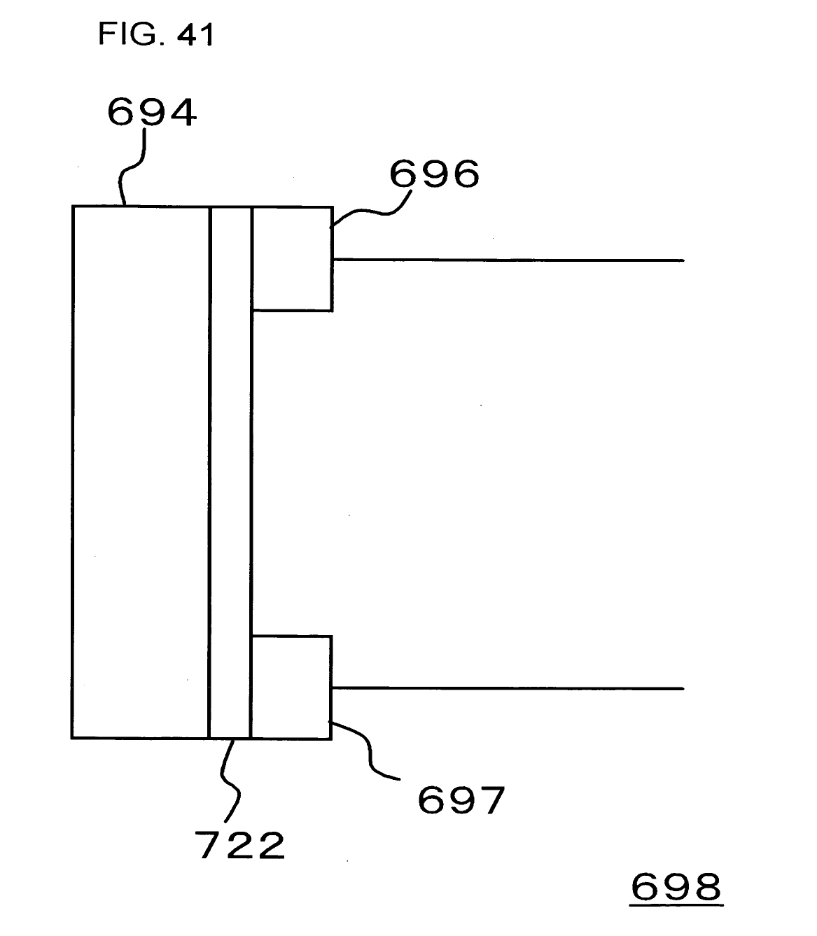

Further, as shown in FIG. 41, the sensor 698 may have a structure in which the first terminal 696 and the second terminal 697 are attached on a quartz 722 to the surface of which the polymer membrane 694 is stuck. In this case, the concentration measurement unit 670 transmits microwave by changing the oscillation frequency from the first terminal 696 of the sensor 698 and receives the reflected wave from the second terminal 697 and thus detects the size alteration of the polymer membrane 694 depending on the resonance frequency characteristics.

(Fourth Embodiment)

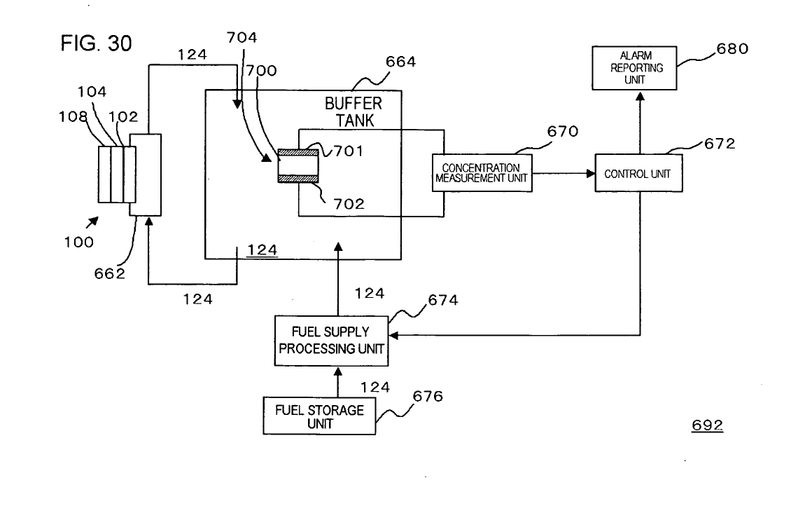

As shown in FIG. 30, a fuel cell system 692 may include a sensor 704 in place of the sensor 698. The sensor 704 is a capacitor including a first electrode 701 and a second electrode 702. In the sensor 704, the first electrode 701 and the second electrode 702 sandwich a polymer membrane 700. In this case, the polymer membrane 700 is made of an insulating material. The polymer membrane 700 may be made of any materials provided that it is insulator and the size of which is changeable depending on the alcohol concentration of the fuel 124. As the polymer membrane 700, for example, aromatic polyether, polyphenylene sulfide, polyimide, polyphosphazene, and trifluorostyrene copolymer (BAM3G, manufactured by Ballard Corporation.) may be exemplified. Further, those polymer membranes including sulfonic acid used as the solid electrolyte membrane 114 of the fuel cell main body 100 may be used after making them insulator by radiating electron beam, UV, x-ray or being immersed in a salt.

In this case, the concentration measurement unit 670 may include an electric capacity measurement unit which measures the electric capacity between the first electrode 701 and the second electrode 702 of the sensor 704 in place of the resistance measurement unit 682 shown in FIG. 23. The concentration calculation unit 684 calculates the alcohol concentration in the buffer tank 664 based on the electric capacity change measured by the electric capacity measurement unit. Further, the reference data storing unit 685 stores the reference data showing the correlation between the electric capacity between the first electrode 701 and the second electrode 702, and the alcohol concentration. In the case a material whose size is changeable depending on the alcohol concentration of the fuel 124 is used for the polymer membrane 700, when the sensor 704 is immersed in the fuel 124, the thickness of the polymer membrane 700 is changed corresponding to the alcohol concentration of the fuel 124 and following that, the distance between the first electrode 701 and the second electrode 702 is changed. Since the electric capacity of a capacitor changes in inverse proportion to the distance between the first electrode 701 and the second electrode 702, the thickness change of the polymer membrane 700 can be detected by measuring the electric capacity between the first electrode 701 and the second electrode 702. The alcohol concentration in the buffer tank 664 can be calculated based on the alteration of the thickness change of the polymer membrane 700.

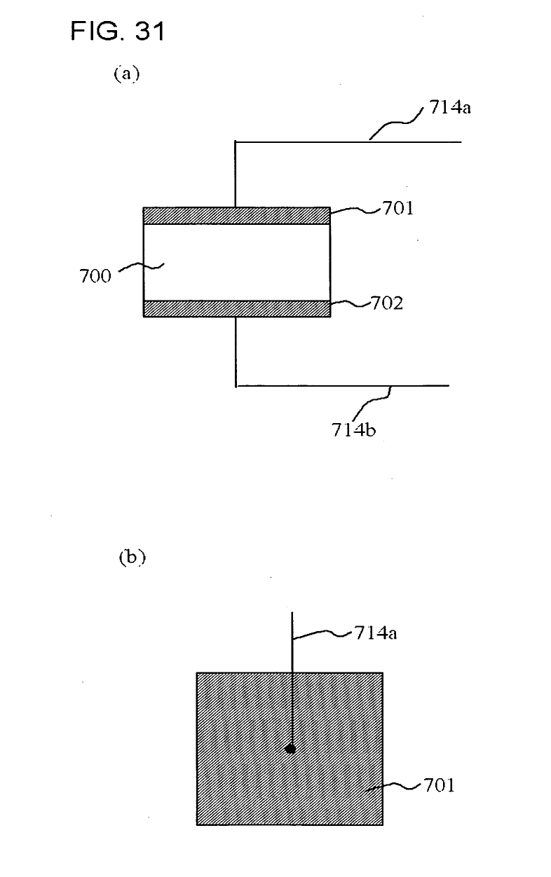

FIG. 31 is a drawing showing the sensor 704 in detail. FIG. 31(a) is a side view of the polymer membrane 700, the first electrode 701 and the second electrode 702 sandwiching the polymer membrane 700, FIG. 31(b) is a top view observing the sensor 704 from the first electrode 701 side. The first electrode 701 and the second electrode 702 are electrically connected to the concentration measurement unit 670 shown in FIG. 30 via wiring 714a and wiring 714b, respectively.

Also, although not shown in the drawings, the alteration of the size of the polymer membrane 700 can be measured by a method of radiating microwave to the polymer membrane 700, changing the oscillation frequency, receiving the reflected wave, and detecting the size (thickness) change of the polymer membrane 700 depending on the resonance frequency characteristics.

According to the fuel cell system 692 of this embodiment, the alcohol concentration of the liquid fuel can be detected with a simple structure.

(Fifth Embodiment)

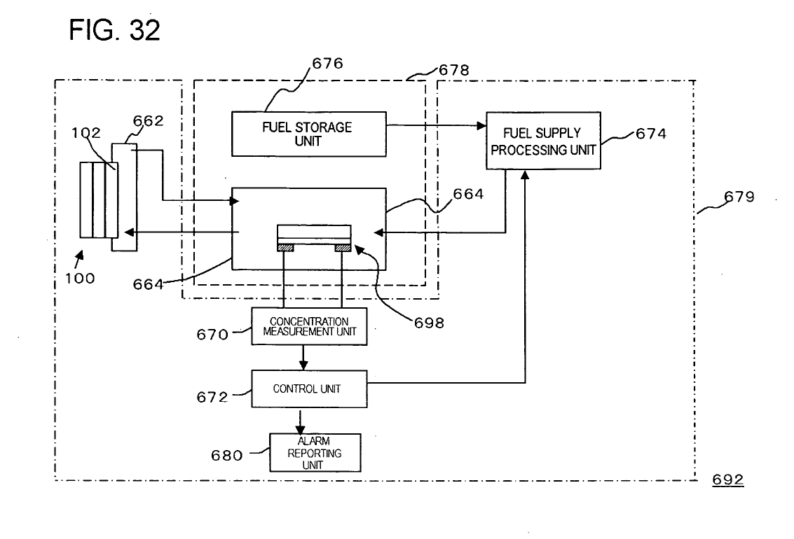

FIG. 32 is a drawing showing one example of the structure of a fuel cell system of the second embodiment of the invention. In this embodiment, a cartridge 678 is attached to the fuel cell system 692.

The cartridge 678 includes a buffer tank 664 and a fuel storage unit 676. The main body side 679 of the fuel cell system 692 includes the fuel cell main body 100, the fuel electrode tank 662, the fuel supply processing unit 674 the concentration measurement unit 670, and the control unit 672. Same symbols are assigned to the element components same as those explained in the third embodiment with FIG. 20, and the explanation to them will properly be omitted.

Here, the fuel supply processing unit 674 is composed so as to supply fuel 124 contained in a fuel storage unit 676 of the cartridge 678 to the buffer tank 664 when the cartridge 678 is attached. In the cartridge 678, the buffer tank 664 contains a sensor 698. In the main body side 679, terminals (not shown in the drawing) to be electrically connected with a first terminal 696 and a second terminal 697 of the sensor 668 when the cartridge 678 is attached are formed in concentration measurement unit 670. The fuel electrode tank 662 is composed so as to introduce the fuel 124 from the buffer tank 664.

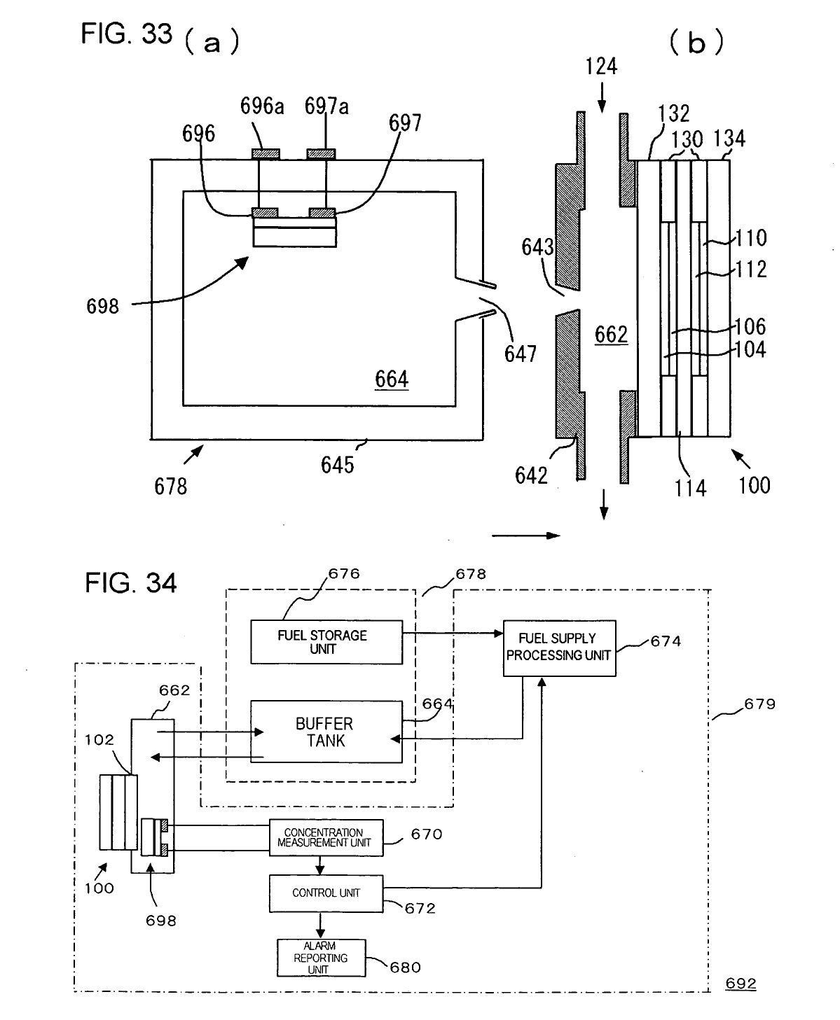

FIG. 33 is a schematic drawing showing the buffer tank 664 in the cartridge 678 and the fuel electrode tank 662 in the main body side 679. A fuel supply port 643 is formed in the fuel electrode tank 662 and the buffer tank 664 has a fitting unit 647 to be fitted with the fuel supply port 643 of the fuel electrode tank 662. A terminal 696a and a terminal 697 a respectively connected with the first terminal 696 and the second electrode terminal 697 of the sensor 698 are formed at a side wall of the cartridge main body 645.

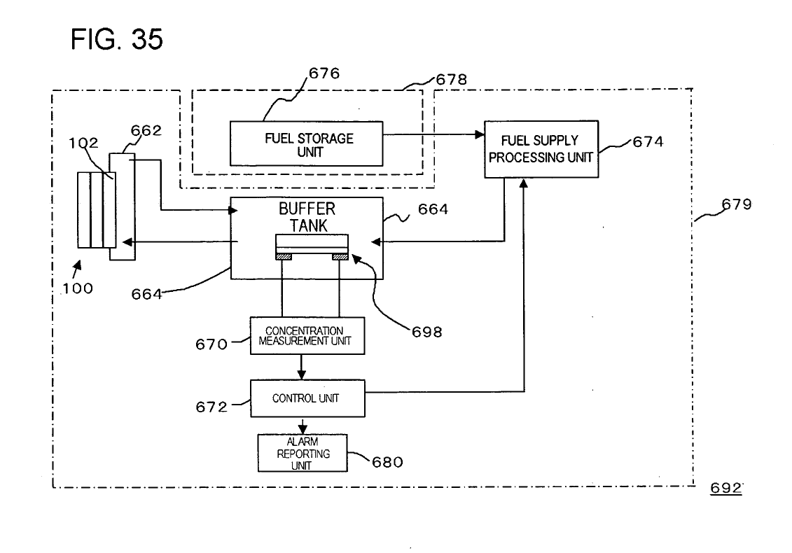

As shown in FIG. 34, the sensor 698 may be provided in the fuel electrode tank 662 of the main body side 679. Further, as shown in FIG. 35, the fuel cell system 692 may be composed so as to make the cartridge 678 containing only the fuel storage unit 676 detachable thereto. Also, although not shown in the drawings, the cartridge 678 may be composed to contain a valve.

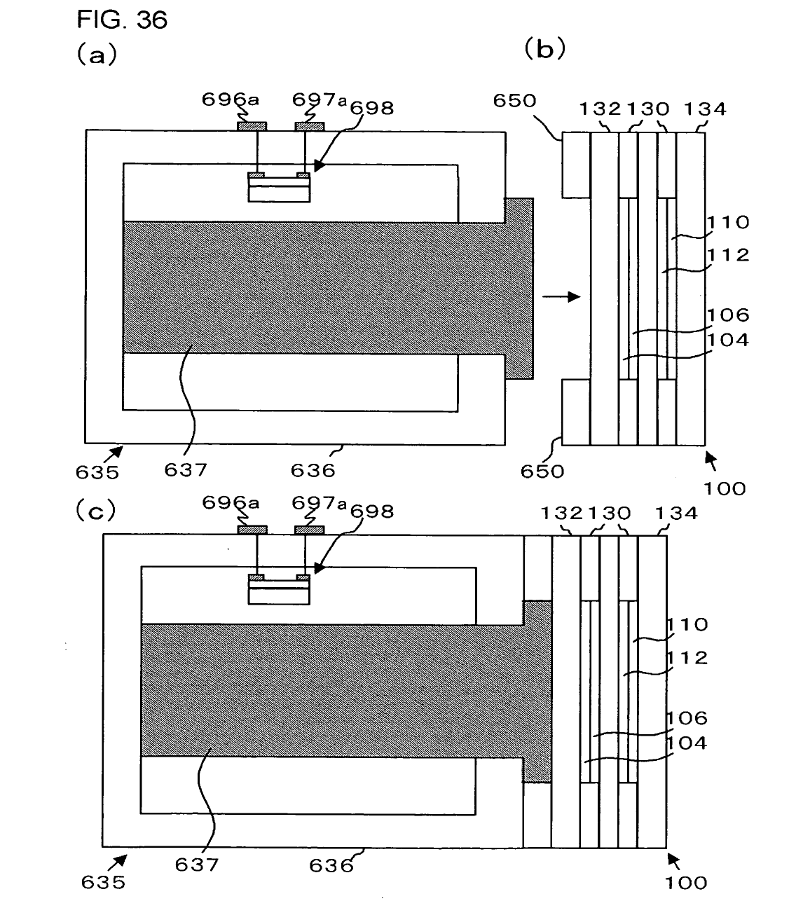

FIG. 36 is a drawing showing another example of the cartridge 678 shown in FIG. 33. Here, the buffer tank 664 of the cartridge 678 contains a fuel supply member 637. In this example, in the fuel cell main body 100, the fuel electrode tank 662 is not provided and the fuel contained in the buffer tank 664 is supplied to the fuel electrode 102 of the fuel cell main body 100 via the fuel supply member 637. The fuel supply member 637 is made of a material capable of absorbing the fuel 124 and supplying the absorbed fuel to the fuel cell main body 100. The fuel supply member 637 is, for example, made of an urethane. Further, the fuel supply member 637 may be made of ceramic porous bodies such as a silica porous body and an alumina porous body; and porous films of fluoro resin, polyethylene, polypropylene, polycarbonate, polyimide, polysulfone, polysulfide, and polybenzimidazole.

The fuel cell system 692 including the sensor 704 as described in the fourth embodiment, may include the cartridge described in this embodiment as well.

### EXAMPLE 2

A Nafion N117 membrane (manufactured by E.I. du Pont de Nemours and Co., thickness of which is about 50 μm, width of which is about 5 mm, and length of which is about 60 mm) was used as a polymer membrane 694 and a strain gauge was attached to the surface of the polymer membrane 694 to provide a sensor 698. Aqueous methanol solutions with known concentrations (methanol concentration 0%, 20%, 40%, and 60%) were introduced into a container and the resistance value between the electrodes of the strain gauge was measured by a direct current source meter provided with a bridge. The correlation between the methanol concentrations in the aqueous methanol solutions and the alteration degrees of the resistance values. In such a manner, the alcohol concentration could accurately be detected by detecting the strain of the polymer membrane 694.

TABLE 1

| | RESISTANCE |
|---|---|
| MeOH (%) | CHANGE (%) |
| 0 | 0.0 |
| 20 | 5.0 |
| 40 | 10 |
| 60 | 22 |

While the invention has been described with reference to specific embodiments, the description is illustrative of the invention and is not to be construed as limiting the invention. Various modifications by combination among constructive elements or processes may occur to those skilled in the art without departing from the spirit and scope of the invention.

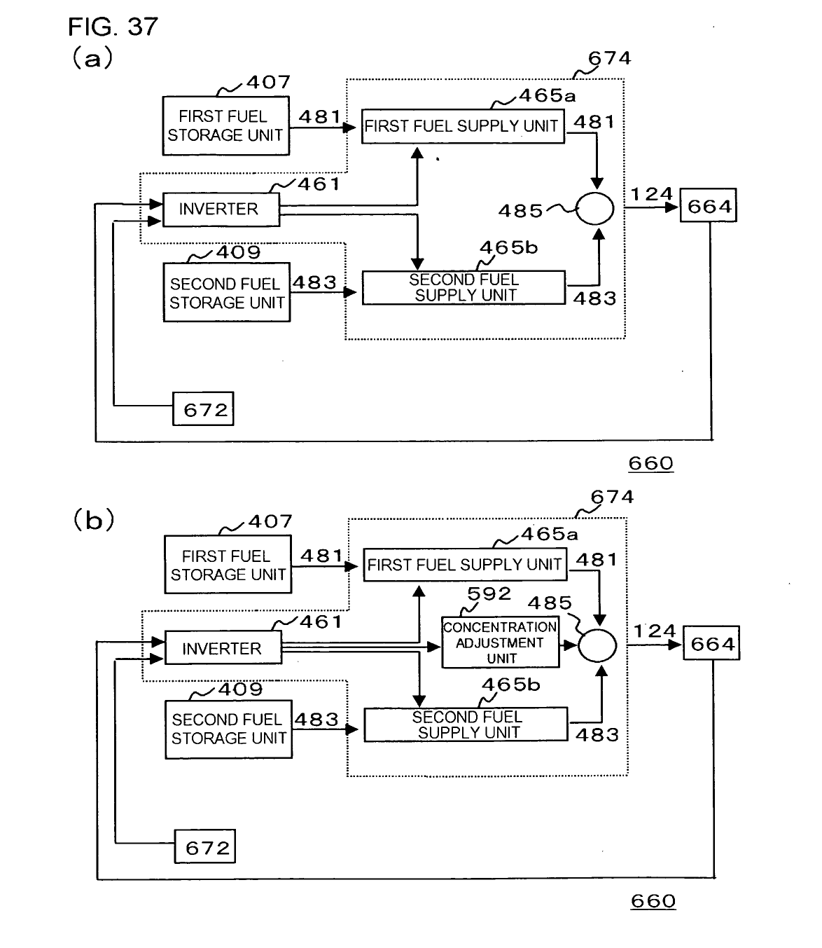

As shown in FIG. 37, the fuel cell system 660 may include two fuel storage units and two fuel supply units respectively. In this case, as shown in FIG. 37(a), the fuel cell system 660 includes a first fuel storage unit 407 and a second fuel storage unit 409 in place of the fuel storage unit 676. The fuel supply processing unit 674 includes a first fuel supply unit 465a, a second fuel supply unit 465b, an inverter 461, and a mixing unit 485. The first fuel supply unit 465a supplies a first fuel component 481 to the mixing unit 485 from the first fuel storage unit 407. The second fuel storage unit 409 supplies a second fuel component 483 to the mixing unit 485 from the second fuel storage unit 409. The first fuel component 481 and the second fuel component 483 supplied from the first fuel storage unit 407 and the second fuel storage unit 409 are mixed in the mixing unit 485 and supplied as fuel 124 to the fuel cell main body 100. The first fuel supply unit 465a and the second fuel supply unit 465b are both connected to the inverter 461 and the supply amounts therefrom are respectively controlled by a control unit 672. The first fuel component 481 and the second fuel component 483 may be, for example, water and methanol. The mixing unit 485 may be a throttle valve or a piezoelectric valve.

As shown in FIG. 37(b), the fuel cell system 660 may further includes a concentration adjustment unit 592. The concentration adjustment unit 592 adjusts the mixing unit 485 and thus controls the mixing ratio of the first fuel component 481 and the second fuel component 483 respectively supplied from the first fuel storage unit 407 and the second fuel storage unit 409. The concentration adjustment unit 592 is connected with the inverter 461 and is controlled by the control unit 672.

In such a manner, in the fuel supply processing unit 674 with the structure shown in FIG. 37, since the supply amounts of two fuel components are separately controlled, the concentration of fuel 124 can properly be adjusted. Further, two fuel components are supplied to the fuel cell main body 100 after being mixed by the mixing unit 485, the two fuel components are evenly mixed and supplied to the fuel cell main body 100.

Similarly, the fuel cell system 692 described in the third to fifth embodiments, may include two fuel storage units and two fuel supply units.

The fuel supply processing unit 674 may include three or more fuel supply units. In this case, the fuel cell system 660 may include three or more fuel storage units.

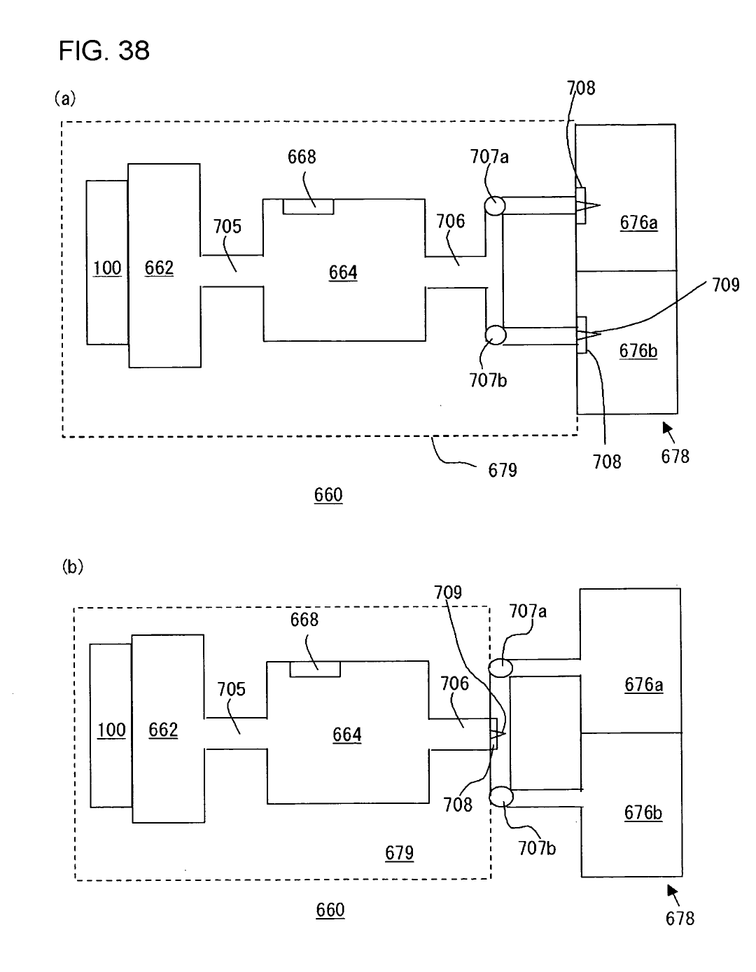

The fuel cell system 660 may be composed to have the structure as shown in FIG. 38. As shown in FIG. 38, the cartridge 678 may include a first fuel storage unit 676a and a second fuel storage unit 676b containing fuel with a different alcohol concentration from that of the alcohol concentration in the first fuel storage unit 676a. Either one of the first fuel storage unit 676a and the second fuel storage unit 676b may store water containing no alcohol. Although it is not shown in the drawing, the water discharged after fuel supply to the fuel cell main body 100 may be turned back and circulated to either the first fuel storage unit 676a or the second fuel storage unit 676b.

FIG. 38(a) is a drawing showing that a first pump 707a and a second pump 707b are provided in the main body side 679. Syringes 709 are provided at the end of the first pump 707a and the second pump 707b in the main body side 679. Caps 708 of silicon rubber or the like, for example, are provided at the first fuel storage unit 676a and the second fuel storage unit 676b of the cartridge 678. By piercing the caps 708 of the cartridge 678 with the syringes 709 of the main body side 679, the first pump 707a and the second pump 707b are operated to supply the fuel from the first fuel storage unit 676a and the second fuel storage unit 676b to the main body side 679. Although it is not shown in the drawing, the first pump 707a and the second pump 707b may be controlled by the control unit 672 (see FIG. 14 for example) and depending on the concentration of the fuel in the buffer tank 664 measured by the sensor 668, supply amounts of the fuel from the first fuel storage unit 676a and the second fuel storage unit 676b can be controlled. Here, the example in which the sensor 668 is provided in the buffer tank 664 is shown, the sensor 668 may be provided in the fuel electrode tank 662 and also in a pipe 705 connecting the buffer tank 664 and the fuel electrode tank 662 and also in a pipe 706 connecting the buffer tank 664 to the first pump 707a and the second pump 707b.

As shown FIG. 38(b), the first pump 707a and the second pump 707b may be provided in the cartridge 678. Also, in this case, the first pump 707a and the second pump 707b can be controlled by the control unit 672 while being electrically connected with the control unit 672 (see FIG. 14 for example) when the cartridge 678 is attached to the main body side 679.

Although the example in which the buffer tank 664 is provided in the main body side 679 is shown in FIG. 38, the fuel cell system 660 may not include the buffer tank 664 and may be composed so as to directly introduce the fuel supplied from the cartridge 678 to the fuel electrode tank 662 through the pipe 706 or the pipe 705.

The sensor 668, sensor 698 and sensor 704 may be used for measuring the alcohol concentration before reforming in a fuel cell system where methanol is reformed to produce hydrogen gas and use hydrogen gas as fuel.

The sensor 668, sensor 698 and sensor 704 may be used not only for the alcohol concentration measurement in the fuel cell system 660 or the fuel cell system 692 but also for the alcohol concentration measurement in a various kinds of solutions. For example, they may be used for measuring the alcohol concentration in alcohol beverages.

1. A fuel cell system using a liquid fuel containing an alcohol comprising:
a fuel cell main body including a solid polymer electrolytic membrane, and a fuel electrode and an oxidant electrode attached to said solid electrolyte membrane;
a container containing said liquid fuel;
a polymer membrane having proton conductivity and provided inside of said container or at the wall portion of said container; and
a concentration detection unit which detects the alcohol concentration of said liquid fuel in said container based on the alteration of the proton conductivity of said polymer membrane when said polymer membrane is immersed with said liquid fuel.

2. The fuel cell system according to claim 1,
wherein said concentration detection unit includes a pair of electrode terminals attached to said polymer membrane, a resistance measurement unit which measures the resistance value between said electrode terminals, and a concentration calculation unit which calculates the alcohol concentration of said liquid fuel based on the resistance value measured by said resistance measurement unit.

3. The fuel cell system according to claim 2,
wherein said electrode terminals of said concentration detection unit are placed at outside of said container.

4. The fuel cell system according to claim 2,
wherein said concentration detection unit includes a hydrophobic membrane covering said electrode terminals.

5. The fuel cell system according to claim 1,
wherein a portion of said solid polymer electrolytic membrane is used as said polymer membrane.

6. The fuel cell system according to claim 1, further comprising a plurality of polymer membranes having different proton conductivities with respect to temperature or pH,
wherein said concentration detection unit detects the alcohol concentration in said liquid fuel based on the respective alterations of the proton conductivities of said plurality of polymer membranes in consideration of temperature or pH of said liquid fuel in said container.

7. The fuel cell system according to claim 1,
wherein said polymer membrane includes a protonic acid group.

8. A fuel cell system using a liquid fuel containing an alcohol comprising:
a fuel cell main body including a solid polymer electrolytic membrane, and a fuel electrode and an oxidant electrode attached to said solid electrolyte membrane;
a container containing said liquid fuel;
a polymer membrane provided inside of said container or at the wall portion of said container and changeable in size in accordance with the concentration of the alcohol concentration of said liquid fuel when being immersed with said liquid fuel; and
a concentration detection unit which detects the alteration degree of the size of said polymer membrane and detects the alcohol concentration of said liquid fuel in said container based on the alteration degree of the size.

9. The fuel cell system according to claim 8,
wherein said concentration detection unit includes a strain gauge attached to said polymer membrane, a resistance measurement unit which measures the resistance alteration of said strain gauge, and a concentration calculation unit which converts the resistance alteration measured by said resistance measurement unit into the alcohol concentration of said liquid fuel.

10. The fuel cell system according to claim 8,
wherein a portion of said solid polymer electrolytic membrane is used as said polymer membrane.

11. The fuel cell system according to claim 8,
wherein said concentration detection unit includes a capacitor composed so as to sandwich said polymer membrane, an electric capacity measurement unit which measures the electric capacity of said capacitor, and a concentration calculation unit which detects the size alteration of said polymer membrane based on the alteration of the electric capacity measured by said electric capacity measurement unit and converts the size alteration degree into the alcohol concentration of said liquid fuel.

12. The fuel cell system according to claim 8,
wherein said concentration detection unit includes a quartz oscillator attached to said polymer membrane, a resonance frequency characteristic measurement unit which detects the alteration of the resonance frequency of said quartz oscillator, and a concentration calculation unit which converts the resonance frequency characteristic measured by said resonance frequency characteristic measurement unit into the alcohol concentration of said liquid fuel.

13. The fuel cell system according to claim 8,
wherein said polymer membrane includes a protonic acid group.

14. The fuel cell system according to claim 8, further comprising a plurality of polymer membranes having different size alteration degrees with respect to temperature and pH,
wherein said concentration detection unit detects the alcohol concentration in said liquid fuel based on the respective size alteration degrees of said plurality of polymer membranes in consideration of temperature or pH of said liquid fuel in said container.

15. The fuel cell system according to claim 1, wherein said polymer membrane is crosslinked.

16. The fuel cell system according to claim 1, further comprising a cartridge detachable from the fuel cell main body,
wherein said container is provided in said cartridge.

17. The fuel cell system according to claim 1, further comprising:
a fuel electrode tank which has a fuel injection inlet and supplies said liquid fuel to said fuel electrode; and
a cartridge which has a fitting unit to be fitted with said fuel injection inlet of said fuel electrode tank and is detachable from said fuel electrode tank,
wherein said container is provided in said cartridge.

18. The fuel cell system according to claim 1, further comprising:
a different concentration fuel storage unit which stores a liquid fuel with a different alcohol concentration from that of said liquid fuel in said container;
a supply unit which supplies said liquid fuel to said container from said different concentration fuel storage unit; and
a control unit which adjusts the supply amount of said liquid fuel to be supplied by said supply unit depending on the alcohol concentration of said liquid fuel in said container detected by said concentration detection unit.

19. The fuel cell system according to claim 18, further comprising a fuel electrode tank which has a fuel injection inlet and supplies said liquid fuel to said fuel cell main body;
wherein said container includes a fitting unit to be fitted with said fuel injection inlet of said fuel electrode tank and a first connection unit for connection to said supply unit, said container being detachable from said fuel electrode tank and said supply unit, and said different concentration fuel storage unit includes a second connection unit for connection to said supply unit, said different concentration fuel storage unit being detachable from said supply unit.

20. The fuel cell system according to claim 19,
wherein said container and said different concentration fuel storage unit are unitedly formed.

21. The fuel cell system according to claim 1, further comprising a temperature sensor which measures the temperature in said liquid fuel in said container,
wherein said concentration detection unit corrects the alcohol concentration of said liquid fuel in said container based on the temperature measured by said temperature sensor.

22. The fuel cell system according to claim 1, further comprising a pH measurement unit which measures pH of said liquid fuel in said container,
wherein said concentration detection unit corrects the alcohol concentration of said liquid fuel in said container based on the pH measured by said pH measurement unit.

23. The fuel cell system according to claim 1, further comprising:
an alarm reporting unit which reports an alarm; and
a control unit which instructs said alarm reporting unit for reporting an alarm when the alcohol concentration of said liquid fuel in said container detected by said concentration detection unit is not within a predetermined range.

24. An alcohol concentration measurement apparatus, comprising:
a polymer membrane which has a proton conductivity, said proton conductivity being changeable when being immersed with an alcohol-containing liquid, in accordance with the alcohol concentration of said liquid; and
a concentration detection unit which detects the alcohol concentration of said liquid based on the alteration of the proton conductivity of said polymer membrane.

25. The alcohol concentration measurement apparatus according to claim 24,
wherein said concentration detection unit includes a pair of electrode terminals attached to said polymer membrane, a resistance measurement unit which measures the resistance value between the electrode terminals, and a concentration calculation unit which converts the resistance value measured by said resistance measurement unit into the alcohol concentration in said liquid.

26. An alcohol concentration measurement apparatus comprising:
a polymer membrane which shows size alteration when an alcohol-containing liquid is immersed therewith, depending on the concentration of the alcohol concentration in said liquid; and
a concentration detection unit which detects the alteration degree of the size of said polymer membrane and detects the alcohol concentration of said liquid based on the alteration degree of the size.

27. The alcohol concentration measurement apparatus according to claim 26,
wherein said concentration detection unit includes a strain gauge attached to said polymer membrane, a resistance measurement unit which measures the resistance alteration of said strain gauge, and a concentration calculation unit which converts the resistance alteration measured by said resistance measurement unit into the alcohol concentration of said liquid fuel.

28. A method of measuring the alcohol concentration, comprising:
immersing an alcohol-containing liquid which is a target to be measured to a polymer membrane having a proton conductivity;
detecting the alteration of the proton conductivity of said polymer membrane; and
detecting the alcohol concentration in said liquid based on the alteration of the proton conductivity.

29. The method of measuring the alcohol concentration according to claim 28,
wherein said detecting the alteration of the proton conductivity includes measuring the resistance value of a pair of electrode terminals attached to said polymer membrane, and
wherein said detecting the alcohol concentration includes calculating the alcohol concentration of said liquid based on the resistance value.

30. The method of measuring the alcohol concentration according to claim 28, further comprising saturating said liquid with carbon dioxide gas before said detecting the alteration of the proton conductivity of said polymer membrane.

31. A method of measuring the alcohol concentration, comprising:
immersing an alcohol-containing liquid which is a target to be measured to a polymer membrane showing size alteration when being impregnated with said liquid;
detecting the size alteration of said polymer membrane; and
detecting the alcohol concentration of said liquid based on the size alteration of said polymer membrane.

32. The method of measuring the alcohol concentration according to claim 31,
wherein said detecting the size alteration includes measuring the resistance alteration of a strain gauge attached to said polymer membrane, and
said detecting the alcohol concentration includes converting the resistance alteration measured in said measuring resistance into the alcohol concentration of said liquid.

33. The method of measuring the alcohol concentration according to claim 31,
wherein said detecting the size alteration includes measuring the electric capacity of a capacitor composed so as to sandwich said polymer membrane, and
said detecting the alcohol concentration includes detecting the size alteration of said polymer membrane based on the alteration of the electric capacity measured in said measuring the electric capacity, and converting the size alteration degree into the alcohol concentration of said liquid fuel.

34. The method of measuring the alcohol concentration according to claim 31,
wherein said detecting the size alteration includes measuring the alteration of resonance frequency of a quartz oscillator attached to said polymer membrane, and
said detecting the alcohol concentration includes detecting the size alteration of said polymer membrane based on the alteration of the resonance frequency measured in said measuring the resonance frequency, and converting the size alteration degree into the alcohol concentration of said liquid fuel.

35. A fuel storage container detachable to a fuel cell system which includes a fuel cell main body, a first electrode terminal, a second electrode terminal, and a voltage application unit which applies voltage between said first electrode terminal and said second electrode terminal, and reserving a liquid fuel supplied to said fuel cell main body, comprising:
a polymer membrane having a proton conductivity; and
a third electrode terminal and a fourth electrode terminal which are attached to said polymer membrane and electrically connected to said first electrode terminal and said second electrode terminal, respectively.

36. A fuel storage container detachable to a fuel cell system which includes a fuel cell main body, a first electrode terminal, a second electrode terminal, and a voltage application unit which applies voltage between said first electrode terminal and said second electrode terminal, and reserving a liquid fuel supplied to said fuel cell main body, comprising:
a polymer membrane changeable in size when being immersed with an alcohol-containing liquid;
a strain gauge which is attached to said polymer membrane; and
a third electrode terminal and a fourth electrode terminal which are electrically connected to said first electrode terminal and said second electrode terminal, respectively to output resistance alteration of said strain gauge.

37. The fuel cell system according to claim 8, wherein said polymer membrane is crosslinked.

38. The fuel cell system according to claim 8, further comprising a cartridge detachable from the fuel cell main body,
wherein said container is provided in said cartridge.

39. The fuel cell system according to claim 8, further comprising:
a fuel electrode tank which has a fuel injection inlet and supplies said liquid fuel to said fuel electrode; and
a cartridge which has a fitting unit to be fitted with said fuel injection inlet of said fuel electrode tank and is detachable from said fuel electrode tank,
wherein said container is provided in said cartridge.

40. The fuel cell system according to claim 8, further comprising:
a different concentration fuel storage unit which stores a liquid fuel with a different alcohol concentration from that of said liquid fuel in said container;
a supply unit which supplies said liquid fuel to said container from said different concentration fuel storage unit; and
a control unit which adjusts the supply amount of said liquid fuel to be supplied by said supply unit depending on the alcohol concentration of said liquid fuel in said container detected by said concentration detection unit.

41. The fuel cell system according to claim 40, further comprising a fuel electrode tank which has a fuel injection inlet and supplies said liquid fuel to said fuel cell main body;
wherein said container includes a fitting unit to be fitted with said fuel injection inlet of said fuel electrode tank and a first connection unit for connection to said supply unit, said container being detachable from said fuel electrode tank and said supply unit, and said different concentration fuel storage unit includes a second connection unit for connection to said supply unit, said different concentration fuel storage unit being detachable from said supply unit.

42. The fuel cell system according to claim 41,
wherein said container and said different concentration fuel storage unit are unitedly formed.

43. The fuel cell system according to claim 8, further comprising a temperature sensor which measures the temperature in said liquid fuel in said container,
wherein said concentration detection unit corrects the alcohol concentration of said liquid fuel in said container based on the temperature measured by said temperature sensor.

44. The fuel cell system according to claim 8, further comprising a pH measurement unit which measures pH of said liquid fuel in said container,
wherein said concentration detection unit corrects the alcohol concentration of said liquid fuel in said container based on the pH measured by said pH measurement unit.

45. The fuel cell system according to claim 8, further comprising:
an alarm reporting unit which reports an alarm; and
a control unit which instructs said alarm reporting unit for reporting an alarm when the alcohol concentration of said liquid fuel in said container detected by said concentration detection unit is not within a predetermined range.
